(19) United States
(12) Patent Application Publication
(10) Pub. No.: US 2008/0019511 A1
(43) Pub. Date: Jan. 24, 2008

(54) ENCRYPTION APPARATUS, DECRYPTION APPARATUS, PROGRAM, AND METHOD

(76) Inventors: Koichiro Akiyama, Tokyo (JP); Yasuhiro Goto, Hakodate-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/685,302

(22) Filed: Mar. 13, 2007

(30) Foreign Application Priority Data
Jul. 19, 2006 (JP) 2006-197488

(51) Int. Cl. H04L 9/30; G06F 1/02; G06F 7/72

(52) U.S. Cl. 380/30; 708/270; 708/491

(57) ABSTRACT

An encryption apparatus generates two random three-variable polynomials r(x,y,t) and s(x,y,t) to be constituted of like terms of a variable xⁱy^{j} (where i and j are degrees that are zero or more) when two multiplication results X(x,y,t)r(x,y,t) and f(t)s(x,y,t) are regarded as polynomials of x and y, and generates an encrypted text F from a plaintext polynomial m(t) by using the two multiplication results X(x,y,t)r(x,y,t) and f(t)s(x,y,t).

### CROSS-REFERENCE TO RELATED APPLICATIONS

This application is based upon and claims the benefit of priority from prior Japanese Patent Application No. 2006-197488, filed Jul. 19, 2006, the entire contents of which are incorporated herein by reference.

### BACKGROUND OF THE INVENTION

1. Field of the Invention

The present invention relates to an encryption apparatus, a decryption apparatus, a program, and a method used in a public key encryption system.

2. Description of the Related Art

As typical public key cryptography systems, there are RSA cryptography and elliptic curve cryptosystems. Since general decryption methods for these public key cryptographies are not known, no serious problems concerning security exist, except for a later-explained decryption method using a quantum computer. As other public key cryptographies, there are a knapsack encryption, a multivariate encryption, and others. However, since there is a decryption method for knapsack encryption, the security of this encryption has been called into question. To counter this, a key size in multivariate encryption is increased, and hence a prevailing attacking method can be avoided. However, this encryption has a problem that the key size becomes enormous.

On the other hand, if a quantum computer were to be used, it would be possible to decrypt RSA cryptography and that of the elliptic curve cryptosystem. Being different from current computers, the quantum computer is a computer that can utilize a physical phenomenon called entanglement in quantum theory to execute a huge number of parallel computations. The quantum computer is an ideal computer on an experimental level, and it has been studied and developed toward realization. In 1994, Shor demonstrated that a quantum computer can efficiently solve factorization into prime factors or a discrete logarithm problem. Therefore, if the quantum computer is realized, it will become possible to decrypt RSA cryptography based on factorization into prime factors or the elliptic curve cryptosystem based on a discrete logarithm problem on an elliptic curve.

On the other hand, there has been studied a public key cryptography system that is safe even if a quantum computer is realized. For example, there is quantum public key cryptography. In the quantum public key cryptography, a quantum computer generates a key for the knapsack encryption that is secure so that the key cannot be produced by a current computer. Therefore, in the quantum public key cryptography, a secure knapsack encryption that cannot be calculated by a quantum computer can be constituted. However, in the quantum public key cryptography, a current computer cannot generate its key, and hence this cryptography cannot be utilized at the present day.

On the other hand, the multivariate encryption can be realized even in the present day, and even a quantum computer cannot decrypt this system. However, since the multivariate encryption requires a massive key size, as explained above, the realization of this encryption is questionable.

Further, as compared with a symmetric key cryptography, the public key cryptography has a larger circuit scale and a longer processing time. Therefore, there is a problem that the public key cryptography cannot be realized in a low-power environment, e.g., a mobile terminal, or a waiting time is long even if it is realized. Therefore, public key cryptography that can be realized even in a low-power environment has been demanded.

In general, the public key cryptography is configured to be equivalent to finding a problem that is difficult to calculate, e.g., a prime factorization problem or a discrete logarithm problem in advance and solving the problem that is difficult to calculate when trying to decrypt an encrypted text without knowing a private key.

However, even if a problem that is difficult to calculate is found, public key cryptography having this problem as a basis for security cannot be readily constituted. That is because a problem that generates a key also becomes difficult when a problem that is too difficult to calculate is a basis for security, and hence the key cannot be produced. On the other hand, when a problem allows easy generation of a key, decryption also becomes easy.

Therefore, in order to constitute public key cryptography, a problem that is difficult to calculate must be found, and the found problem must be remade into a problem having an adequate balance so that a key can be readily generated but cannot be easily decrypted. Such remake of a problem requires high creativity. Actually, remaking a problem is very difficult, and hence only a few public key cryptographies have been proposed.

Under such a situation, there is a possibility that even a quantum computer cannot efficiently perform decryption. As a public key cryptography system that can perform processing at a high speed even in a low-power environment, public key cryptography using an algebraic curve has been proposed (see, e.g., JP-A 2005-331656 (KOKAI) or associated U.S. application Ser. No. 11/128,283).

The public key cryptography system that uses an algebraic curve is explained below. That is, a private key is determined as two sections corresponding to an algebraic curve X (x,y,t), and a public key is determined as an algebraic curve X (x,y,t). At this time, an encrypted text F=Eₚₖ(m,s,r,f,X) is generated from a plaintext polynomial m(t) based on processing of embedding a plaintext m in the plaintext polynomial m(t), processing of randomly generating a one-variable irreducible polynomial f(t) having a degree L, processing of generating randomized polynomials s(x,y,t) and r(x,y,t) having three variable x, y, and t, and processing of calculating respective polynomials s(x,y,t), r(x,y,t), and f(t) and a definitional equation X(x,y,t). According to this system, a later-explained section finding problem on an algebraic surface is a basis for security, and hence decryption is difficult.

The public key cryptography using an algebraic surface usually has no problem. However, according to an examination by the present inventor, a part of r(x,y,t) may possibly leak due to analysis of an encrypted text F depending on randomized polynomials s(x,y,t) and r(x,y,t).

Additionally, in regard to generation of the randomized polynomials s(x,y,t) and r(x,y,t), conditions concerning degrees of the randomized polynomials are disclosed, but a generation algorithm is not disclosed. Therefore, a part of r(x,y,t) may possibly leak due to analyzing an encrypted text F depending on the generated randomized polynomials s(x,y,t) and r(x,y,t).

### BRIEF SUMMARY OF THE INVENTION

A first aspect of the present invention is an encryption apparatus comprising: an embedding device configured to embed a message m as a coefficient of a plaintext polynomial m(t) having one variable t and a degree that is L−1 or less when encrypting the message m if a fibration X(x,y,t) of an algebraic surface X is a public key and two or more sections corresponding to the fibration X(x,y,t) are private keys; an irreducible polynomial generation device configured to generate a random one-variable irreducible polynomial f(t) having a degree that is L or more; a polynomial generation device configured to random three-variable polynomials r(x,y,t) and s(x,y,t) to be constituted of like terms of a variable xⁱy^{j} (where i and j are degrees that are zero or more) when “a multiplication result X(x,y,t)r(x,y,t) of the fibration X(x,y,t) and a three-variable polynomial r(x,y,t)” and “a multiplication result f(t)s(x,y,t) of the random one-variable polynomial f(t) having a degree that is L or more and a three-variable polynomial s(x,y,t)” are regarded as polynomials of x and y; and an encryption device configured to generate an encrypted text F=Eₚₖ(m,s,r,f,X) from the plaintext polynomial m(t) by processing of executing addition or subtraction using the multiplication result X(x,y,t)r(x,y,t) and the multiplication result f(t)s(x,y,t) with respect to the plaintext polynomial m(t).

A second aspect of the present invention is an encryption apparatus comprising: an embedding device configured to embed a message m as a coefficient of a plaintext polynomial m(t) having one variable t and a degree that is L−1 or less when encrypting the message m if a fibration X(x,y,t) of an algebraic surface X is a public key and a section corresponding to the fibration X(x,y,t) is a private key; an irreducible polynomial generation device configured to generate a random one-variable irreducible polynomial f(t) having a degree that is L or more; a first polynomial generation device configured to generate random three-variable polynomials r₁(x,y,t) and s₁(x,y,t) to be constituted of like terms of a variable xⁱy^{j} (where i and j are degrees that are zero or more) when “a multiplication result X(x,y,t)r₁(x,y,t) of the fibration X(x,y,t) and the three-variable term r₁(x,y,t)” and “a multiplication result f(t)s₁(x,y,t) of the random one-variable irreducible polynomial f(t) having a degree that is L or more and the three-variable polynomial s₁(x,y,t)” are regarded as polynomials of x and y; a first encryption device configured to generate a first encrypted text F₁=Eₚₖ(m,s₁,r₁,f,X) from the plaintext polynomial m(t) by processing of executing addition or subtraction using the multiplication result X(x,y,t)r₁(x,y,t) and the multiplication result f(t)s₁(x,y,t) with respect to the plaintext polynomial m(t); a second polynomial generation device configured to generate random three-variable polynomials r₂(x,y,t) and s₂(x,y,t) to be constituted of like terms of a variable xⁱy^{j} (where i and j are degrees that are zero or more) when “a multiplication result X(x,y,t)r₂(x,y,t) of the fibration X(x,y,t) and the three-variable term r₂(x,y,t)” and “a multiplication result f(t)s₂(x,y,t) of the random one-variable irreducible polynomial f(t) having a degree that is L or more and the three-variable polynomial s₂(x,y,t)” are regarded as polynomials of x and y; and a second encryption device configured to generate a second encrypted text F₂=Eₚₖ(m,s₂,r₂,f,X) from the plaintext polynomial m(t) by processing of executing addition or subtraction using the multiplication result X(x,y,t)r₂(x,y,t) and the multiplication result f(t)s₂(x,y,t) with respect to the plaintext polynomial m(t).

A third aspect of the present invention is a decryption apparatus comprising: an input device configured to input an encrypted text F=Eₚₖ(m,s,r,f,X) generated by processing of executing addition or subtraction using “a multiplication result X(x,y,t)r(x,y,t) of a fibration X(x,y,t) and a three-variable polynomial r(x,y,t)” and “a multiplication result f(t)s(x,y,t) of a random one-variable irreducible polynomial f(t) having a degree that is L or more and a three-variable polynomial s(x,y,t)” constituted of like terms of a variable xⁱy^{j} (where i and j are degrees that are 0 or more) when a plaintext polynomial m(t) having one variable t and a degree that is (L−1) or less in which a message m is embedded as a coefficient of the plaintext polynomial m(t) is regarded as a polynomial of x and y in case of decrypting the message m from the encrypted text F generated by using a public key as the fibration X(x,y,t) based on a private key as two or more sections D₁ and D₂ corresponding to the fibration X(x,y,t) of an algebraic surface X; an assignment device configured to assign the respective sections D₁ and D₂ to the input encrypted text F to generate two one-variable polynomials h₁(t) and h₂(t); a subtraction device configured to subtract the respective one-variable polynomials h₁(t) and h₂(t) to obtain a subtraction result {h₁(t)−h₂(t)}; a factorization device configured to factorize the subtraction result {h₁(t)−h₂(t)}; an extraction device configured to extract all irreducible polynomials f(t) having degrees that are L or more from a factorization result; a dividing device configured to divide the one-variable polynomial h₁(t) by the extracted irreducible polynomial f(t) to obtain a polynomial candidate m₁(t) as a residue, and divide the one-variable polynomial h₂(t) by the irreducible polynomial f(t) to obtain a polynomial candidate m₂(t) as a residue; an inspection device configured to inspect whether the polynomial candidates m₁(t) and m₂(t) match with each other; a development device configured to develop the message m from the polynomial candidate m₁(t) or m₂(t) when both the candidates match with each other as a result of the inspection; a control device configured to control the residue arithmetic device to execute the division based on the other extracted irreducible polynomials when both the candidates do not match with each other as a result of the inspection; and an output device configured to output an error when both the candidates do not match with each other as a result of the inspection and the other irreducible polynomials f(t) are not present.

A fourth aspect of the present invention is a decryption apparatus comprising: a first input device configured to input an encrypted text F₁=Eₚₖ(m, s₁, r₁, f, X) generated by processing of executing addition or subtraction using “a multiplication result X(x,y,t)r₁(x,y,t) of a fibration X(x,y,t) and a three-variable polynomial r₁(x,y,t)” and “a multiplication result f(t)s₁(x,y,t) of a random one-variable irreducible polynomial f(t) having a degree that is L or more and a three-variable polynomial s₁(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the plaintext polynomial m(t) is regarded as a polynomial of x and y in case of decrypting the message m from a plurality of encrypted texts F₁ and F₂ generated by using a public key as the fibration X(x,y,t) based on a private key as a section D corresponding to the fibration X(x,y,t) of an algebraic surface X; a second input device configured to input the encrypted text F₂=Eₚₖ(m,s₂,r₂,f,X) generated by processing of executing addition or subtraction using “a multiplication result X(x,y,t)r₂(x,y,t) of the fibration X(x,y,t) and a three-variable polynomial r₂(x,y,t) (≠r₁(x,y,t))” and “a multiplication result f(t)s₂(x,y,t) of the random one-variable irreducible polynomial f(t) having a degree that is L or more and a three-variable polynomial s₂(x,y,t)” constituted of like terms of a variable xⁱy^{j} (where i and j are degrees that are zero or more) when the plaintext polynomial m(t) is regarded as a polynomial of x and y; an assignment device configured to assign the section D to the plurality of input encrypted texts F₁ and F₂ to generate two one-variable polynomials h₁(t) and h₂(t); a subtraction device configured to subtract the respective one-variable polynomials h₁(t) and h₂(t) to obtain a subtraction result {h₁(t)−h₂(t)}; a factorization device configured to factorize the subtraction result {h₁(t)−h₂(t)}; an extraction device configured to extract all irreducible polynomials f(t) having degrees that are L or more from a factorization result; a dividing device configured to divide the one-variable polynomial h₁(t) by the extracted irreducible polynomial f(t) to obtain a polynomial candidate m₁(t) as a residue, and divide the one-variable polynomial h₂(t) by the irreducible polynomial f(t) to obtain a polynomial candidate m₂(t) as a residue; an inspection device configured to inspect whether the polynomial candidates m₁(t) and m₂(t) match with each other; a development device configured to develop the message m from the polynomial candidate m₁(t) or m₂(t) when both the candidates match with each other as a result of the inspection; a control device configured to control the residue arithmetic device to execute the division by using the other extracted irreducible polynomials f(t) when both the candidates do not match with each other as a result of the inspection; and an output device configured to output an error when both the candidates do not match with each other as a result of the inspection and the other extracted irreducible polynomials are not present.

It is to be noted that each of the above-explained aspects uses an expression “apparatus”, but the present invention is not restricted thereto. It is needless to say that other expressions, e.g., a “method”, a “program”, or a “computer-readable storage medium” can be used.

In the first and the third aspects, two multiplication results X(x,y,t)r(x,y,t) and f(t)s(x,y,t) included in an encrypted text F are formed of like terms concerning a variable xⁱy^{j} when these results are regarded as polynomials of x and y. Therefore, even if a technique that analyzes a term that is present in one multiplication result X(x,y,t)r(x,y,t) but not in the other multiplication result f(t)s(x,y,t) is used, each term cannot be recognized, and a part of r(x,y,t) does not leak.

Therefore, it is possible to avoid leakage of a randomized polynomial in public key cryptography using an algebraic surface.

In the second and the fourth aspects, for the same reason as that of the first and the third aspects, even if encrypted texts F₁ and F₂ are analyzed, a part of r₁(x,y,t) and r₂(x,y,t) does not leak, thereby avoiding leakage of a randomized polynomial in public key cryptography using an algebraic surface.

### BRIEF DESCRIPTION OF THE SEVERAL VIEWS OF THE DRAWING

FIG. 1 is a schematic view for illustrating a general algebraic curve;

FIG. 2 is an overall block diagram of an encryption apparatus according to a first embodiment;

FIG. 3 is an overall block diagram of a decryption apparatus according to the first embodiment;

FIGS. 4 to 6 are flowcharts of the encryption apparatus according to the first embodiment;

FIGS. 7 and 8 are flowcharts of the decryption apparatus according to the first embodiment;

FIG. 9 is a flowchart of a variation of decryption processing in the first embodiment;

FIGS. 10 to 14 are flowcharts of an encryption apparatus according to a second embodiment;

FIGS. 15 and 16 are flowcharts of a decryption apparatus according to the second embodiment; and

FIG. 17 is a flowchart of a variation of decryption processing according to the second embodiment.

### DETAILED DESCRIPTION OF THE INVENTION

Each embodiment according to the present invention will now be described with reference to the accompanying drawings.

An algebraic surface in each embodiment is defined as one having a two-dimensional freedom degree in a set of solutions of a simultaneous (algebraic) equation defined in a field K. For example, since a simultaneous equation in the field K represented as the following Expression (1) has three equations that constrain five variables, it has a two-dimensional freedom degree, and hence it is an algebraic surface.

$$\{ \begin{matrix}{f}_{1} ( x , y , z , v , w ) = 0 \\ {f}_{2} ( x , y , z , v , w ) = 0 \\ {f}_{3} ( x , y , z , v , w ) = 0\end{matrix} \qquad ( 1 )$$

In particular, as represented by Expression (2), a space defined as a set of solutions of an algebraic equation in the field K having three variables is also an algebraic surface in the field K.
f(x,y,z)=0 (2)

It is to be noted that a definitional equation of the algebraic surface represented by Expressions (1) and (2) is an equation in an affine space. A definitional equation of an algebraic surface in a projective space (in case of Expression (2)) is f(x,y,z,w)=0.

However, in each embodiment, the algebraic surface is not processed in the projective space, and hence a definitional equation of the algebraic surface is determined as Expression (1) or Expression (2). However, even if this definitional equation is expressed in the projective space, each embodiment can be achieved as it is.

On the other hand, an algebraic curve is one having a one-dimensional freedom degree in a set of solutions of a simultaneous (algebraic) equation defined in the field K. Therefore, the algebraic curve is defined by, e.g., the following expression.
g(x,y)=0

In this embodiment, since an algebraic surface that can be written in one expression like Expression (2) is used, Expression (2) is used like a definitional equation of the algebraic surface in the following explanation.

The field is a set in which addition, subtraction, multiplication, and division can be freely carried out. A real number, a rational number, and a complex number correspond to the field. A set including an element that cannot be divided except by zero, e.g., an integer or a matrix does not correspond to the field. In fields, there is a field constituted of a finite number of elements called a finite field. For example, a residue class Z/pZ having a modulo p with respect to a prime number p forms a field. Such a field is called a prime field, and written as Fₚ or the like. As finite fields, there is, e.g., a field Fq(q=p^{r}) having elements obtained by raising a prime number. However, in this embodiment, a prime field Fₚ alone is mainly used for the sake of convenience. In general, p in the prime field Fₚ is called a characteristic of the prime field Fₚ.

On the other hand, even in the case of coping with a general finite field, each embodiment can be likewise achieved by carrying out a self-evident modification. It is often the case that public key cryptography is constituted in a finite field because a message is embedded as digital data. In this embodiment, likewise, an algebraic surface defined in a finite field (a prime field in particular in this embodiment) Fₚ is used.

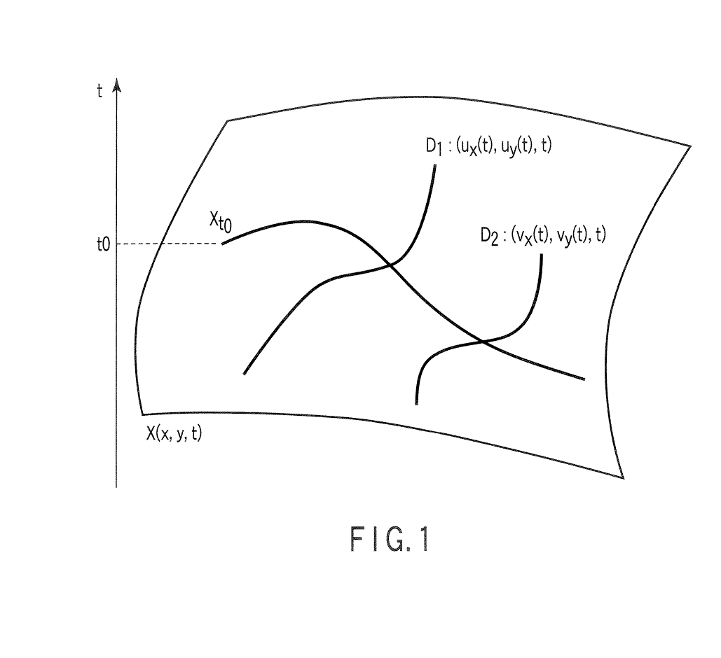

As shown in FIG. 1, a plurality of algebraic curves are usually present on an algebraic surface f(x,y,z)=0. Such an algebraic curve is called a factor on an algebraic surface.

In general, a problem of finding a (non-self-evident) divisor when a definitional equation of an algebraic surface is given is a difficult problem that is unsolvable even in contemporary mathematics. Except for a primitive method, e.g., solving such a multivariate equations as described later or a round-robin solution, a general solving method is unknown. In particular, in an algebraic surface defined by such a finite field as used in this embodiment, there are not so many clues as compared with an infinite field (a field constituted of infinite number of elements), e.g., a rational number field, and it is known that it is a very difficult problem.

In this embodiment, this problem is called a divisor finding problem on an algebraic surface or simply a divisor finding problem, and a public key cryptography system having a divisor finding problem on an algebraic surface as a basis for security is constituted.

Next, on an algebraic surface X:f(x,y,z)=0 in a field K, x and y are defined by the following expression and called sections:
h(x,y,t)=0
An algebraic curve expressed in a form in which a curve represented by the following expression obtained by parameterizing x,y with t exists is called a fibration of an algebraic surface X and expressed as Xₜ or the like:
(x,y,t)=(uₓ(t),u_{y}(t),t)
It is to be noted that since a fibration is apparent in the following explanation, such an algebraic surface is simply represented as X.

Further, an algebraic surface obtained by assigning an element t0 of the field K to a parameter t is called a fiber and expressed as, e.g., Xₜ₀. Both the fiber and the section are divisors of the algebraic surface Xₜ.

In general, when a fibration of an algebraic surface is given, a corresponding fiber can be immediately obtained (by assigning an element of a field to t). However, finding a corresponding section is very difficult. Therefore, it can be said that the fiber is a trivial divisor and the section is a non-trivial divisor.

A public key cryptography system in each embodiment determines a problem of obtaining a section as a basis for security when especially a fibration Xₜ of an algebraic surface X is given in a problem of finding divisors on an algebraic surface.

In order to obtain a section from a fibration, only a method based on the following procedure from (i) to (iv) is known even in contemporary mathematics.

(i) A section (uₓ(t), u_{y}(t),t) is assumed as deg uₓ(t)<rₓ, deg u_{y}(t)<r_{y}, and uₓ(t) and u_{y}(t) are then set, as in the following expressions:
uₓ(t)=α₀+α₁t+ . . . +αᵣ_{ₓ}₋₁t^{r}^{ₓ}⁻¹
u_{y}(t)=β₀+β₁t+ . . . +αᵣ_{_{y}}₋₁t^{r}^{_{y}}⁻¹

(ii) uₓ(t) and u_{y}(t) are assigned to X(x,y,t)=to obtain the following expression:

$$X ( {u}_{x} ( t ) , {u}_{y} ( t ) , t ) = {\sum }_{i} {c}_{i} {t}^{i} = 0$$

(iii) The left-hand side of the above expression is developed to express a coefficient of tᵢ by using a function cᵢ(α₀, . . . , αᵣ_{ₓ}₋₁, β₀, . . . , βᵣ_{_{y}}₋₁) of α₀, . . . , αᵣ_{ₓ}ₚ₁, β₀, . . . , βᵣ_{_{y}}₋₁, thereby achieving the following the system of multivariate equations:

$$\{ \begin{matrix}{c}_{0} ( {α}_{0} , … , {α}_{{r}_{x} - 1} , {β}_{0} , … , {β}_{{r}_{y} - 1} ) = 0 \\ {c}_{1} ( {α}_{0} , … , {α}_{{r}_{x} - 1} , {β}_{0} , … , {β}_{{r}_{y} - 1} ) = 0 \\ ⋮ \\ {c}_{{r}_{x} + {r}_{y} - 2} ( {α}_{0} , … , {α}_{{r}_{x} - 1} , {β}_{0} , … , {β}_{{r}_{y} - 1} ) = 0\end{matrix}$$

(iv) The system of equations is solved.

Public key cryptography according to this embodiment based on a problem of finding sections on an algebraic surface will now be described specifically.

### FIRST EMBODIMENT

(Outline)

Public key cryptography according to this embodiment has the following two system parameters.

1. A characteristic p of a prime field

2. A degree L of a one-variable irreducible polynomial f(t) on Fₚ

Furthermore, a public key is;

1. a fibration of an algebraic surface X on Fₚ:
X(x,y,t)=0.
A private key is
1. a section of the algebraic surface X on Fₚ:

D₁: (x,y,t)=(uₓ(t),u_{y}(t),t); and

2. a section of the algebraic surface X on Fₚ:

D₂:(x,y,t)=(vₓ(t),v_{y}(t),t).

These keys can be readily obtained by a later-described key generation method.

An outline of encryption processing will now be explained. In the encryption processing, a message (which will be referred to as a plaintext hereinafter) to be encrypted is divided into blocks as follows:
m=m₀∥m₁∥ . . . ∥m_{L-1}
The blocks are embedded in a plaintext polynomial m(t) as follows (plaintext embedding processing):
m(t)=m_{L-1}t^{L-1}+ . . . +m₁t+m₀
Here, in order to determine m(t) as a polynomial on Fₚ, each mᵢ (0≦i≦L−1) must be taken as an element of Fₚ. That is, the plaintext is divided based on a bit length of p to achieve the following expression:
0≦mᵢ≦p−1
It is to be noted that the plaintext m is an integer and configured by, e.g., reading a character code string representing a message as an integer.

Then, a one-variable irreducible polynomial f(t) having a random degree that is L or more on Fₚ is determined. The irreducible polynomial means a polynomial that cannot be factorized any further. In the case of a one-variable polynomial in a finite field, it is known that a judgment on irreducibility is very easy. It is assumed that a degree of a selected irreducible polynomial is L₀.

Then, randomized polynomials r(x,y,t) and s(x,y,t) in Fₚ are generated, and an encrypted text F(x,y,t) is calculated from expressions m(t) and f(t) and the fibration X(x,y,t) on the algebraic surface X as the public key based on the following Expression (3):
F(x,y,t)=m(t)+f(t)s(x,y,t)+X(x,y,t)r(x,y,t) (3)

In each embodiment, fixed conditions are determined with respect to generation of r(x,y,t) and s(x,y,t) to improve the security, and a size of the encrypted text is configured to facilitate estimation. Therefore, in regard to the following expression in which the algebraic surface X(x,y,t) as the public key is regarded as a polynomial of x and y, a minimum value dₜ of a degree of a coefficient cᵢⱼ(t) is obtained

$${\sum }_{i , j} {c}_{ij} ( t ) {x}^{i} {y}^{j}$$

Then, a monomial rᵢⱼ(t)xⁱy^{j} that produces each term when r(x,y,t) is regarded as a polynomial of x and y is determined. Here, the monomial includes a constant term. Furthermore, rᵢⱼ(t) as a coefficient of each term including the constant term is randomly determined in such a manner that the degree becomes equal to or above L₀−dₜ. As a result, degrees of coefficients of all terms in X(x,y,t)r(x,y,t) as a constituent element in the encrypted text can be set equal to or above the degree of the one-variable irreducible polynomial f(t) that is also a constituent element of the encrypted text.

It is to be noted that, when explaining a coefficient of a three-variable polynomial Σcᵢⱼ(t)xⁱy^{j} in the following, a term cᵢⱼ(t)xⁱy^{j} when this polynomial is regarded as a polynomial of x and y alone is a target unless stated. That is, a coefficient of a term cᵢⱼ(t)xⁱy^{j} of the three-variable polynomial is cᵢⱼ(t), and a degree of the coefficient is a degree concerning t in cᵢⱼ(t). Moreover, a like term of a term ηᵢⱼ(t)xⁱy^{j} when the polynomial is regarded as a polynomial of x and y means a term τᵢⱼ(t)xⁱy^{j} having the same variable xⁱy^{j}. Here, generally, ηᵢⱼ(t) and τᵢⱼ(t) as coefficients of respective terms are not equal to each other (however, when ηᵢⱼ(t)=τᵢⱼ(t), this is also called a like term for the sake of convenience). Additionally, the case where two three-variable polynomials G₁(x,y,t) and G₂(x,y,t) are constituted of the like terms of the variable xⁱy^{j} when regarded as polynomials of x and y is defined as a case where a like term of the term xⁱy^{j} when regarded as a polynomial of x and y included in G₁(x,y,t) is included as a non-zero term (a term having a coefficient that is not zero) of G₂(x,y,t) and vice versa, i.e., a like term of the term xⁱy^{j} when regarded as a polynomial of x and y included in G₂(x,y,t) is included as a non-zero term (a term having a coefficient that is not zero) of G₁(x,y,t).

Then, X(x,y,t)r(x,y,t) is calculated based on r(x,y,t) determined as explained above, and a polynomial s(x,y,t) is determined as follows. That is, the polynomial is randomly determined in such a manner that a degree of a coefficient bᵢⱼ(t) of each term including a like term bᵢⱼ(t)xⁱy^{j} of aᵢⱼ(t)xⁱy^{j} included in calculated X(x,y,t)r(x,y,t) becomes a value obtained by subtracting L₀ from a degree of a coefficient aᵢⱼ(t) of a corresponding term aᵢⱼ(t)xⁱy^{j} in X(x,y,t)r(x,y,t).

Further, a like term of a term that is not included in X(x,y,t)r(x,y,t) is not included (that is, a coefficient is set to zero). In this manner, an expression of X(x,y,t)r(x,y,t) as a constituent element in an encrypted text can be set equal to that of f(t)s(x,y,t). That is, according to this configuration, the expression X(x,y,t)r(x,y,t) and the expression f(t)s(x,y,t) are constituted of the like terms of the variable xⁱy^{j} when they are regarded as polynomials of x and y (however, i and j are degrees equal to or above 0), and degrees of coefficients of corresponding terms match with each other. Therefore, neither of the expressions can be discriminated from each other in form. Furthermore, both the expressions include constant terms because of a creation method of X(x,y,t) and r(x,y,t), and deg f(t)≧L and degₘ(t)<L can be achieved. Therefore, the elements X(x,y,t)r(x,y,t) and f(t)s(x,y,t) included in the encrypted text are noises (random elements) with respect to each other, and they cannot be discriminated from each other. Particularly, in regard to their constant terms, it can be understood that m(t), X(x,y,t)r(x,y,t), and f(t)s(x,y,t) are noises with respect to each other.

Contrarily, if this configuration is not adopted, a term that is included in f(t)s(x,y,t) but not in X(x,y,t)r(x,y,t) or a term that is included in X(x,y,t)r(x,y,t) but not in f(t)s(x,y,t) is present. In the former case, when a coefficient of a term included in f(t)s(x,y,t) alone is factorized, f(t) or a plurality of candidates of f(t) including f(t) can be obtained. In the latter case, a coefficient of a term r(x,y,t) corresponding to a term aᵢⱼ(t)xⁱy^{j} included in X(x,y,t)r(x,y,t) alone can be revealed. However, in any case, it is necessary to specify a term as a corresponding term in advance, and hence security is not immediately threatened. However, such a term may be possibly easily specified because of advancement in decryption technology in the future. Therefore, random polynomials r(x,y,t) and s(x,y,t) must be generated as in each embodiment. Likewise, in regard to constant terms of f(t)s(x,y,t) and X(x,y,t)r(x,y,t), there is a problem that m(t) leaks from a constant term of an encrypted text F(x,y,t) if these constant terms are not present.

A receiver who has received the encrypted text F(x,y,t) first utilizes his/her private keys D₁ and D₂ to perform decryption as follows. First, the sections D₁ and D₂ are assigned to the encrypted text F(x,y,t). Here, the sections D₁ and D₂ are assigned to the algebraic surface X(x,y,t). Attention is drawn to a relationship represented by the following expression:
X(uₓ(t),u_{y}(t),t)=0, X(vₓ(t),v_{y}(t),t)=0
Thus, it can be understood that two expressions h₁(t) and h₂(t) having a relationship represented by the following equations can be obtained:
h₁(t)=F(uₓ(t),u_{y}(t),t)=m(t)+f(t)p(uₓ(t),u_{y}(t),t)
h₂(t)=F(vₓ(t),v_{y}(t),t)=m(t)+f(t)p(vₓ(t),v_{y}(t),t)
Then, the two expressions are respectively subjected to subtraction to calculate the following Expression (4):
h₁(t)−h₂(t)=f(t){p(uₓ(t),u_{y}(t),t)−p(ᵥₓ(t),v_{y}(t),t)} (4)

Subsequently, h₁(t)−h₂(t) is factorized to acquire a factor whose degree is equal to or above L. Here, the number of factors whose degree is equal to or above L is not necessarily one. Thus, these factors are determined as follows:
fᵢ(t)(1≦i≦n)
Moreover, factorization of h₁(t)−h₂(t) can be processed within a sufficiently effective time since factorization of a one-variable polynomial is easy.

Then, h₁(t) is divided by acquired fᵢ(t). If fᵢ(t)=f(t), a plaintext polynomial m(t) can be obtained as a residue from the following relationship while paying attention to the fact that a degree of m(t) is less than L:
h₁(t)=m(t)+f(t)p(uₓ(t),u_{y}(t),t) (5)
However, if there are a plurality of candidates for f(t), the plaintext polynomial m(t) cannot necessarily be obtained. Thus, assuming that a residue obtained here is m₁(t) and a residue obtained by dividing h₂(t) by fᵢ(t) is m2(t), if fᵢ(t)=f(t), m₁(t)=m₂(t) must be achieved. Contrarily, if m₁(t)≠m₂(t), it can be said that fᵢ(t)≠f(t) can be achieved. Therefore, all candidates for fᵢ(t) are examined, and each candidate that succeeds in examination (namely, two residues match with each other) is determined as f(t).

On the other hand, if there are a plurality of candidates that are successful in examination or there is no such a candidate, processing is carried out as a decryption failure. Although the former case cannot be theoretically denied, the probability thereof is negligibly small. Although the latter case cannot theoretically occur, it might occur when decrypting an encrypted text changed due to a calculation error on a transmission side or falsification in a transmission path.

Then, a plaintext m can be obtained from the acquired plaintext polynomial m(t) by a processing opposite to the plaintext embedding processing.

A key creation method in this embodiment will now be explained. In generation of a key according to this embodiment, the sections D₁ and D₂ are randomly selected, and a fibration corresponding to these sections is calculated. However, in order to simultaneously provide the two sections on a generated algebraic surface, the following ingenuity is required. In general, (a fibration of) the algebraic surface can be written as follows:

$$X ( x , y , t ) = {\sum }_{( i , j )} {e}_{ij} ( t ) {x}^{i} {y}^{j}$$

Here, eᵢⱼ(t) is a one-variable polynomial.

First, a characteristic p of a prime field is determined as a system parameter. At this time, even if p is small, no problem occurs in security. Then, the sections D₁ and D₂ are determined as follows:
D₁:(x,y,t)=(uₓ(t),u_{y}(t),t),
D₂:(x,y,t)=(vₓ(t),v_{y}(t),t)
These sections are assigned to the algebraic surface X to obtain the following expressions:
Σ_{(i,j)}eᵢⱼ(t)uₓ(t)ⁱu_{y}(t) ^{j}=0
Σ_{(i,j)}eᵢⱼ(t)vₓ(t)ⁱv_{y}(t) ^{j}=0
When these expressions are subjected to subtraction, a constant term e₀₀(t) common in both the expressions is eliminated, thereby acquiring Expression (6):

$${e}_{10} ( t ) ( {u}_{x} ( t ) - {v}_{x} ( t ) ) = - {\sum }_{( i , j ) \neq ( 0 , 0 ) , ( 1 , 0 )} {e}_{ij} ( t ) ( {{u}_{x} ( t )}^{i} {{u}_{y} ( t )}^{j} - {{v}_{x} ( t )}^{i} {{v}_{y} ( t )}^{j} ) \qquad ( 6 )$$

Here, c₁₀(t) that becomes a polynomial is generated from the following relational expression:
uₓ(t)ⁱu_{y}(t)^{j}−vₓ(t)ⁱv_{y}(t)=(uₓ(t)ⁱ−vₓ(t)ⁱ)u_{y}(t)^{j}+vₓ(t)ⁱ(u_{y}(t)^{j}−v_{y}(t)^{j}) (7)
In order to acquire c₁₀(t), it is good enough to set as follows (it is to be noted that a notation A|B means that B is divisible by A, i.e., that B is a multiple (a multiple expression) of A):
uₓ(t)−vₓ(t)|u_{y}(t)−v_{y}(t)
This is clear from Expression (7) and the following expressions:
(uₓ(t)−vₓ(t))|(uₓ(t)ⁱ−vₓ(t)ⁱ)
(u_{y}(t)−v_{y}(t))|(u_{y}(t)ⁱ−v_{y}(t)ⁱ)

A key can be generated based on the following algorithm by utilizing the above expressions. First, two polynomials that can achieve λₓ(t)|λ_{y}(t) are randomly selected.

Specifically, in order to acquire a set of such polynomials λₓ(t) and λ_{y}(t), assuming that d is determined as a maximum degree of the section, it is good enough to randomly give, e.g., λₓ(t) whose degree is equal to or less than d and calculate λ_{y}(t)=c(t)λₓ(t) based on a random polynomial c(t) whose degree is equal to or smaller than d-deg λₓ(t).

Here, the following expressions are set:
λₓ(t)=uₓ(t)−vₓ(t), λ_{y}(t)=u_{y}(t)−v_{y}(t)
Subsequently, a polynomial vₓ(t) is randomly selected, and uₓ(t) is calculated based on the following expression:
uₓ(t)=λₓ(t)+vₓ(t)
Since degrees of λₓ(t) and vₓ(t) are equal to or smaller than d, a degree of uₓ(t) is also equal to or smaller than d.

Likewise, a polynomial v_{y}(t) is randomly selected, and u_{y}(t) is calculated based on the following expression:
u_{y}(t)=λ_{y}(t)+v_{y}(t)
Likewise, degrees of λ_{y}(t) and v_{y}(t) are equal to or smaller than d, a degree of u_{y}(t) is also equal to or smaller than d.

Then, a coefficient eᵢⱼ(t)((i,j)≠(0,0),(1,0)) other than e₀₀(t) and e₁₀(t)x is randomly generated, and uₓ(t), vₓ(t), u_{y}(t), and v_{y}(t) calculated as described above are utilized to calculate e₁₀(t) in accordance with Expression (6). Further, the polynomial e₀₀(t) can be obtained by calculating the following expression:

$${e}_{00} ( t ) = - {\sum }_{( i , j ) \neq ( 0 , 0 )} {e}_{ij} ( t ) ( {{u}_{x} ( t )}^{i} {{u}_{y} ( t )}^{j} - {{v}_{x} ( t )}^{i} {{v}_{y} ( t )}^{j} ) \qquad ( 8 )$$

<Variation of First Embodiment>

A first variation is a variation concerning a modification of Expression (3) used in encryption processing. Encryption/decryption is likewise possible and the same security can be verified even if Expression (3) is modified as follows:
F(x,y,t)=m(t)−f(t)s(x,y,t)−X(x,y,t)r(x,y,t)
In this manner, an expression of the cryptography can be modified without departing from the scope of the present invention, and decryption processing can be adequately changed in accordance with this modification.

A second variation is a mode of also embedding the plaintext m in the one-variable irreducible polynomial f(t). In the foregoing embodiment, the mode of randomly generating f(t) has been explained. However, since the fact that obtaining f(t) without a private key is difficult is also one of properties of the public key cryptography according to the present invention, the mode of embedding plaintext information in f(t) can be realized.

When embedding the plaintext m in f(t), a plaintext having a larger size can be encrypted at one time. However, since a result f(t) of embedding must be determined as an irreducible polynomial, a specific coefficient must be determined as a random value. There are a large number of irreducible polynomials. Therefore, even if the plaintext m is embedded in some of the coefficients, the irreducible polynomials can be obtained in many cases. Even if the irreducible polynomial cannot be obtained, increasing a degree of f(t) can enlarge a search range. Even if such a modification is carried out, the same security can be realized.

Furthermore, in regard to decryption processing, f(t) is developed together with m(t), and a part of the plaintext m is taken out from predetermined ones of coefficients in f(t), thereby enabling decryption.

A third variation is a mode of decreasing the number of times of plaintext polynomial inspection processing. In this embodiment, two residues m₁(t) and m₂(t) in all candidates for f(t) are compared with each other in the plaintext polynomial inspection processing, and the fact that the residues m₁(t) and m₂(t) of one candidate alone match with each other is confirmed. However, a probability that residues of two or more candidates match with each other is negligibly small. Therefore, in a case where there is a candidate for f(t) having m₁(t) and m₂(t) matching with each other, even if this m₁(t) is configured as a plaintext polynomial, the probability of producing an erroneous plaintext is negligibly small. Moreover, when such a configuration is adopted, a part of the decryption processing can be eliminated, and the same processing can be omitted with respect to other candidates for f(t) (candidates that cannot acquire correct f(t) except with a negligible probability). Therefore, the number of times of the plaintext polynomial inspection processing can be averaged, thereby decreasing this number of times to approximately ½.

<Examination of Security>

The following gives a consideration on security of the public key cryptography according to the present invention having the above-explained configuration as shown in [1] to [3].

[1] Round Robin Attack

Respective elements m(t), f(t), s(x,y,t), and r(x,y,t) constituting an encrypted text F(x,y,t) are determined as follows:

$$\begin{matrix}m ( t ) = {\sum }_{0 \leq i \leq L - 1} {m}_{i} {t}^{i} \\ f ( t ) = {\sum }_{0 \leq i \leq L} {a}_{i} {t}^{i} \\ s ( x , y , t ) = {\sum }_{0 \leq i , j , k \leq n} {b}_{ijk} {x}^{i} {y}^{j} {t}^{k} \\ r ( x , y , t ) = {\sum }_{0 \leq i , j , k \leq n} {c}_{ijk} {x}^{i} {y}^{j} {t}^{k}\end{matrix}$$

An attack that compares these elements with the encrypted text F(x,y,t) to generate the system of multivariate equations and solves this equation can be considered. In this case, however, x and y in r(x,y,t) are regarded as polynomials, many terms are included, and degrees of polynomials serving as coefficients of the respective terms when regarded as polynomials of x and y are sufficiently increased. As a result, the number of variables is increased so that a solution cannot be readily obtained. For example, at present, a system of multivariate equations having approximately 100 variables is very difficult to be solved by the current computer throughput and processing technique. Thus, increasing degrees of terms or coefficients so that the number of variables exceeds 100 can avoid this attack.

[2] Reduction Attack

In the public key cryptography according to each embodiment, the algebraic surface X(x,y,t) alone is disclosed. Thus, whether m(t)+f(t)s(x,y,t) cannot be obtained as a residue produced when dividing the encrypted text F(x,y,t) by X(x,y,t) must be examined. However, in the case of a division of three-variable polynomials, a residue cannot be uniquely determined. That is because a divisional theory cannot be achieved in a polynomial expression having two or more variables as explained in a reference document (D. Cox, et al., “Ideals, Varieties, and Algorithms (Volume 1)”, Springer (200), p. 94, Example 4). Further, the following three conditions are obtained based on properties of the encrypted text:
degₓ(m(t)+f(t)s(x,y,t))>degₓ X(x,y,t)
deg_{y}(m(t)+f(t)s(x,y,t))>deg_{y} X(x,y,t) (9)
degₜ(m(t)+f(t)s(x,y,t))>degₜ X(x,y,t)
A residue having a higher degree than the divisor expression X(x,y,t) must be found, thus making it difficult to obtain the correct residue m(t)+f(t)s(x,y,t). Here, the notion degₓ g(x,y,t) is indicative of a degree when the polynomial g(x,y,t) is regarded as a polynomial of x.

[3] Assignment Attack

[3-1: Attack of Assigning Algebraic Curve on Algebraic Surface]

An algebraic curve (including a section) has ω as a parameter, and can be represented as Expression (10):
x=uₓ(ω), y=u_{y}(ω), t=uₜ(ω) (10)
Here, it is considered that the section corresponds to a special case where ω=t. When a key is produced in accordance with the above-described key generation algorithm, degₜ X(x,y,t) is considerably greater than degₓ X(x,y,t) and deg_{y} X(x,y,t). Therefore, it can be considered that the number of variables when deg uₜ(ω)≧2 makes attacking difficult as compared with a case of the section, i.e., (deg uₜ(ω)=1).

When deg uₜ(ω)=1, since the algebraic curve becomes a section by a simple linear transformation, attacking is difficult on the assumption of difficulty in a problem of finding sections.

When deg uₜ(ω)=0, the algebraic curve is a fiber. The fiber on the algebraic surface can be readily obtained by assigning a special value tᵢ to t on the algebraic surface X(x,y,t) having a fibration.

Therefore, assigning this to the encrypted text F(x,y,t) leads to the following simultaneous equation:
F(uₓ(ω),u_{y}(ω),tᵢ)=m(tᵢ)+f(tᵢ)s(uₓ(ω),u_{y}(ω),tᵢ)
However, a value that substitutes for tᵢ is just p, and hence no information can be obtained from these relational expressions.

[3-2: Attack of Assigning Algebraic Curve outside Algebraic Surface]

An algebraic curve outside an algebraic surface can be also represented as Expression (10), and it is X(uₓ(ω),u_{y}(ω),uₜ(ω)≠0. Therefore, the following expression can be obtained:
F(uₓ(ω),u_{y}(ω),uₜ(ω)=m(uₜ(ω)+f(uₜ(ω)s(uₓ(ω),u_{y}(ω), uₜ(ω)+X(uₓ(ω),u_{y}(ω),uₜ(ω)r(uₓ(ω),u_{y}(ω),uₜ(ω))
Here, since X(uₓ(ω) ,u_{y}(ω) ,uₜ(ω)) is known, an attack of reducing F(uₓ(ω),u_{y}(ω),uₜ(ω)) by x(uₓ(ω),u_{y}(ω),uₜ(ω)) can be considered. This is possible since the number of variables is one. However, based on Expression (9), a degree of m(uₜ(ω)+f(uₜ(ω))s(uₓ(ω),u_{y}(ω),uₜ(ω)) is larger than a degree of X(uₓ(ω),u_{y}(ω),uₜ(ω)), thereby making it difficult to obtain a correct residue.

[3-3: Attack of Assigning Rational Point on Algebraic Surface]

There is an attack of assigning a rational point (a point where X(x,y,t)=0 is achieved) on the algebraic surface X(x,y,t). That is, a₀, a₁, . . . , a_{L-1} are determined as unknown numbers, and a plaintext polynomial is set as follows:
m(t)=a_{L-1}x^{L-1}+ . . . +a₁x+a₀
It is known that K rational points (xᵢ,yᵢ,tᵢ) on an algebraic surface Xₜ(x,y,t) (as a public key) can be relatively easily obtained, and obtained in massive numbers (irrespective of types of algebraic surfaces). Therefore, assigning these rational points to the cipher text F(x,y,t) can acquire the following relational expression:
F(xᵢ,yᵢ,tᵢ)=m(tᵢ)+f(tᵢ)s(xᵢ,yᵢ,tᵢ)
Simultaneously achieving these relational expressions may possibly solve m(t).

However, f(t) and s(x,y,t) are random polynomials. In particular, the following expression includes all terms contained in X(x,y,t)r(x,y,t), and a coefficient having a degree that is a value obtained by subtracting a degree of the one-variable irreducible polynomial f(t) from a degree of a coefficient of each term is randomly written in the term of s(x,y,t):

$$s ( x , y , t ) = {\sum }_{i , j} {s}_{ij} ( t ) {x}^{i} {y}^{j}$$

Therefore, when a degree of each coefficient in r(x,y,t) is sufficiently increased, a degree of a coefficient of s(x,y,t) is also increased so that the equation cannot be solved, and hence a calculation is practically impossible.

Therefore, such an attack is not a threat for the public key cryptography according to the present invention.

On the other hand, when a factor of s(x,y,t) is eliminated from the encrypted text, the following simultaneous equation can be obtained:
F(xᵢ,yᵢ,tᵢ)=m(tᵢ)+f(tᵢ)
Here, the following expression can be achieved:
degₘ(t)<deg f(t)=L
Therefore, even if L is approximately 100, a coefficient can be relatively easily acquired. For this reason, the factor s(x,y,t) is present.

As explained above, the public key cryptography according to each embodiment is resistant to attacks. That is (conversely), each constituent element is set so that the public key cryptography according to each embodiment has resistance properties.

(Specific Structure of First Embodiment)

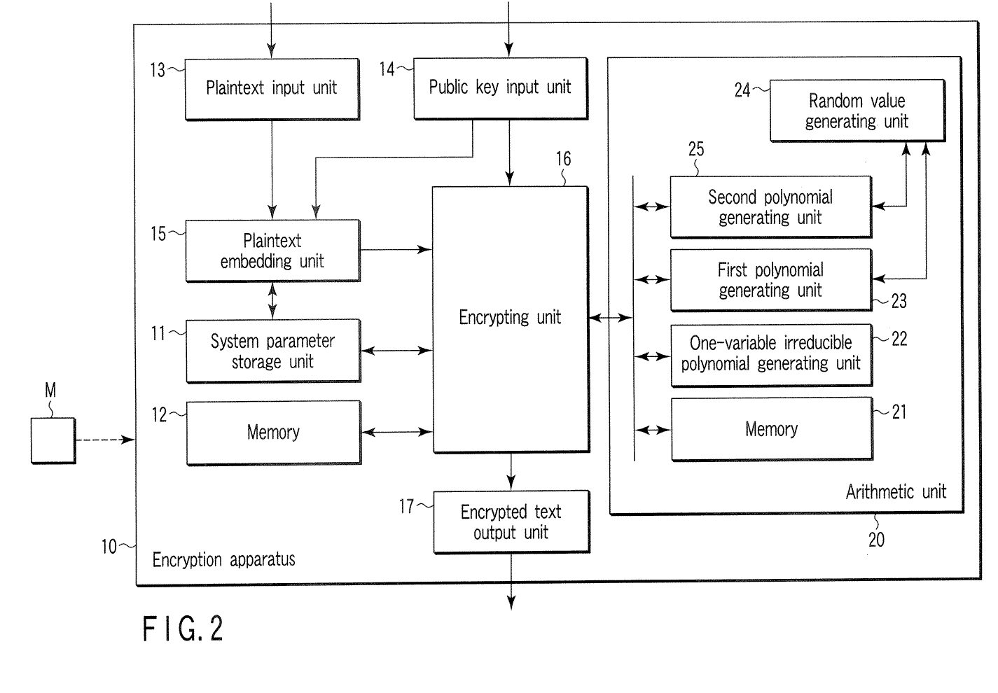

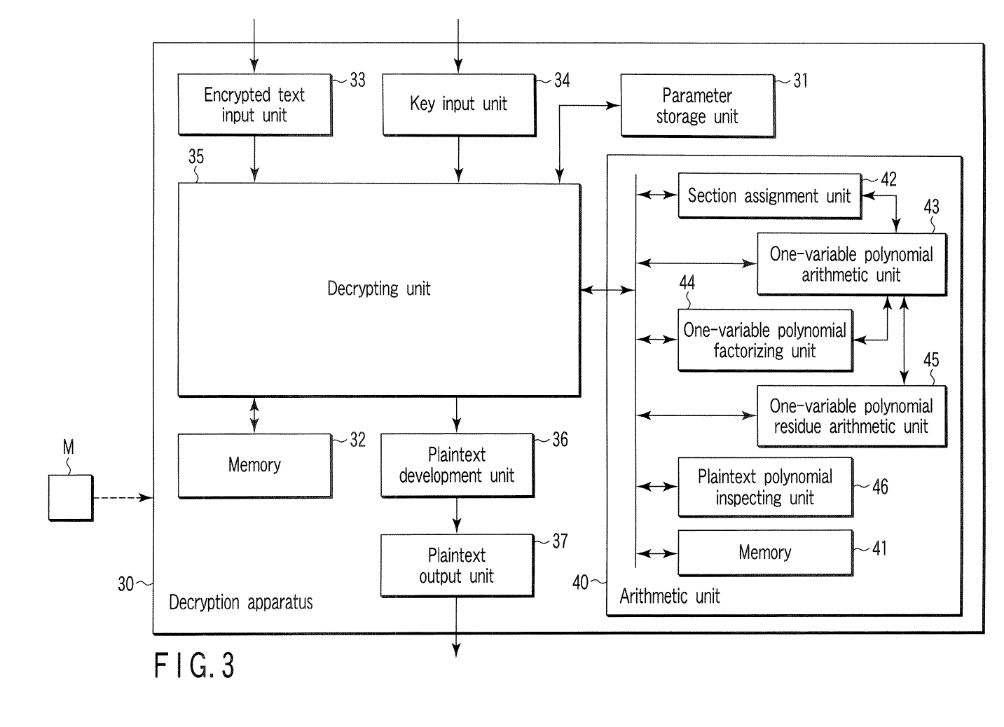

A first Embodiment according to the present invention will now be described. FIG. 2 is an overall block diagram of an encryption apparatus according to the first embodiment of the present invention, and FIG. 3 is an overall block diagram of a decryption apparatus according to the first embodiment.

It is to be noted that each of an encryption apparatus 10 and a decryption apparatus 20 explained below can be realized by using a hardware structure or a combined structure of a hardware resource and software. As software in the combined structure, a program that is installed in a computer in a corresponding apparatus from a network or a storage medium M in advance to realize a function of the corresponding apparatus is used.

Here, as shown in FIG. 2, the encryption apparatus 10 includes a system parameter storage unit 11, a memory 12, a plaintext input unit 13, a public key input unit 14, a plaintext embedding unit 15, an encrypting unit 16, an encrypted text output unit 17, and an arithmetic unit 20. The arithmetic unit 20 includes a memory 21, a one-variable irreducible polynomial generating unit 22, a first polynomial generating unit 23, a random value generating unit 24, and a second polynomial generating unit 25.

The system parameter storage unit 11 is a memory having information that can be read from the encrypting unit 16, and stores a degree L of a one-variable irreducible polynomial f(t) and a characteristic p of a prime field as system parameters.

Data and others that are under processing from the encrypting unit 16 can be appropriately read from/written in the memory (a hardware resource) 12.

The plaintext input unit 13 has a function of transmitting a plaintext (a message) m input from the outside to the plaintext embedding unit 15.

The public key input unit 14 has a function of transmitting a public key X(x,y,t) input from the outside to the plaintext embedding unit 15 and the encrypting unit 16.

The plaintext embedding unit 15 has a function of embedding the plaintext m as a coefficient of a plaintext polynomial m(t) having one variable t and a degree that is L−1 or less based on the plaintext m received from the plaintext input unit 13 and the public key received from the public key input unit 14, and a function of transmitting the obtained plaintext polynomial m(t) to the encrypting unit 16.

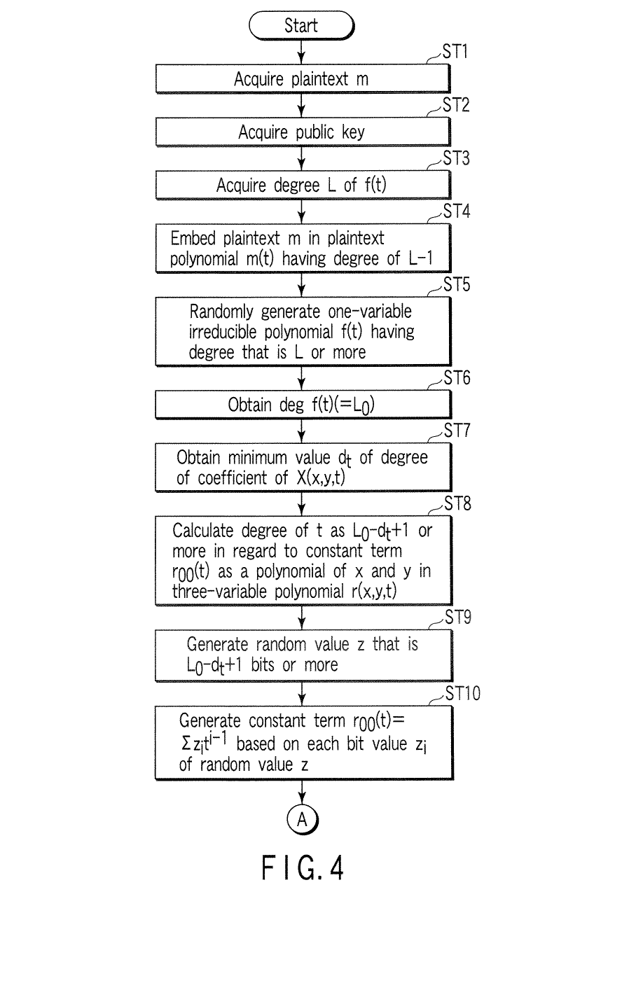

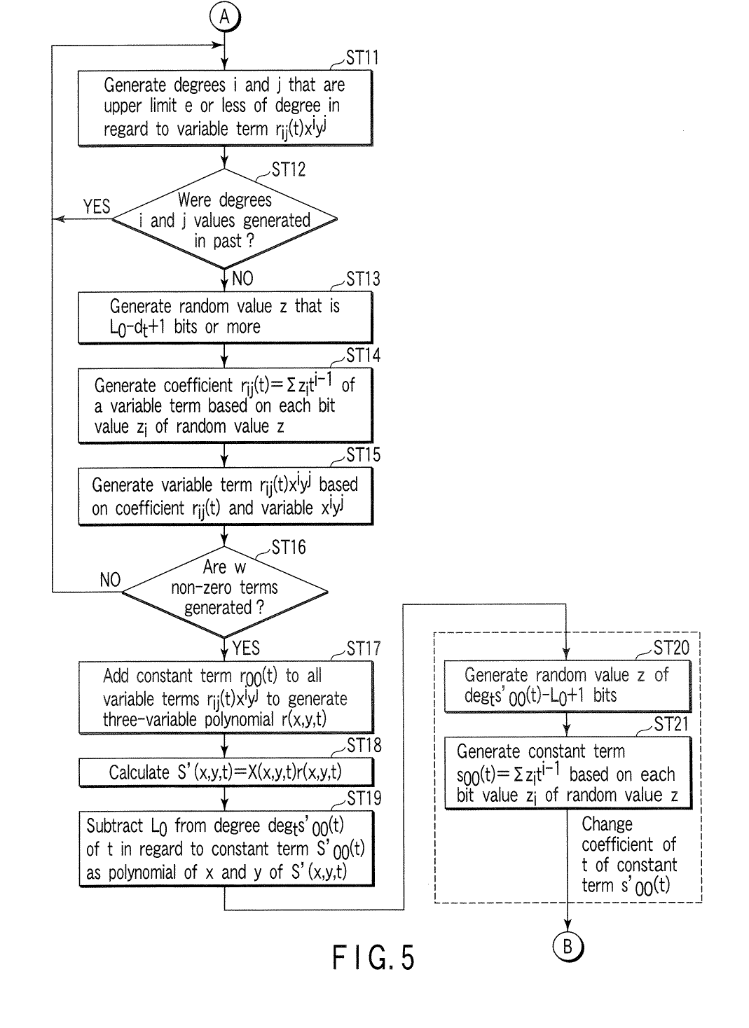

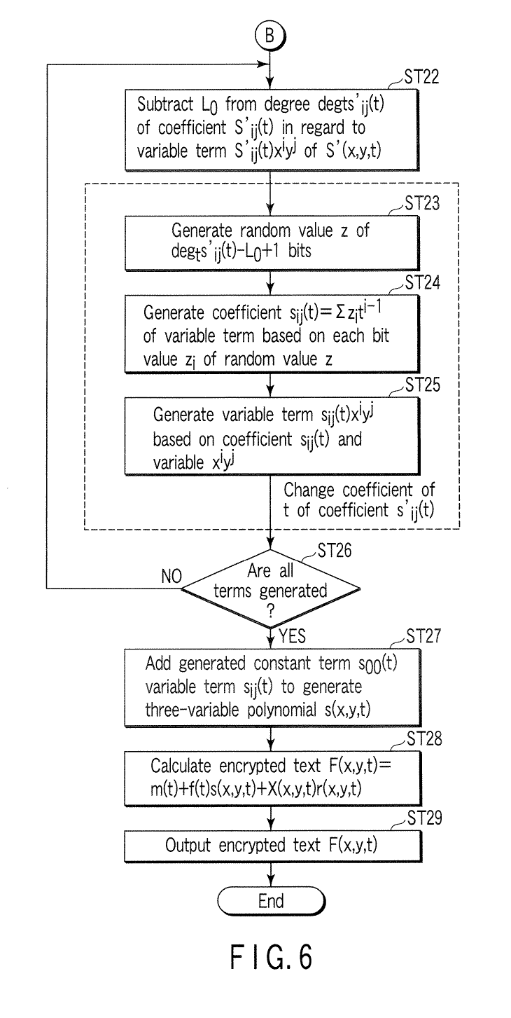

The encrypting unit 16 controls the respective units 17 and 20 to 25 on rear stages to execute operations shown in FIGS. 4 to 6 based on the plaintext polynomial m(t) received from the plaintext embedding unit 13 and the public key X(x,y,t) received from the public key input unit 14. In particular, the encrypting unit 16 has a function of generating an encrypted text F=Eₚₖ(m,s,r,f,X)=F(x,y,t) from the plaintext polynomial m(t) by processing of executing addition or subtraction using “a multiplication result X(x,y,t)r(x,y,t) of a fibration X(x,y,t) and a three-variable polynomial r(x,y,t)” and “a multiplication result f(t)s(x,y,t) of a random one-variable irreducible polynomial f(t) having a degree that is equal to or above L and a three-variable polynomial s(x,y,t)” constituted of like terms of a variable xⁱy^{j} when the plaintext polynomial m(t) is regarded as a polynomial of x and y (where i and j are degrees equal to or above zero).

The encrypted text output unit 17 has a function of outputting the encrypted text F(x,y,t) generated by the encrypting unit 16.

Data and others under processing from the encrypting unit 16 and the respective generating units 22 to 25 can be appropriately read from/written in the memory (a hardware resource) 21.

The one-variable irreducible polynomial generating unit 22 is controlled by the encrypting unit 16, and has a function of generating a random one-variable irreducible polynomial f(t) having a degree that is L or more.

Each of the first polynomial generating unit 23, the random value generating unit 24, and the second polynomial generating unit 25 is controlled by the encrypting unit 16, and has a polynomial generating function of generating random three-variable polynomials r(x,y,t) and s(x,y,t) constituted of like terms of a variable xⁱy^{j} (where i and j are degrees equal to or above zero) when “a multiplication result X(x,y,t)r(x,y,t) of a fibration X(x,y,t) and a three-variable polynomial r(x,y,t)” and “a multiplication result f(t)s(x,y,t) of a random one-variable irreducible polynomial f(t) having a degree equal to or above L and a three-variable polynomial s(x,y,t)” are regarded as polynomials of x and y. Specifically, the first polynomial generating unit 23, the random value generating unit 24, and the second polynomial generating unit 25 have the following functions.

The first polynomial generating unit 23 is controlled by the encrypting unit 16 and has: a function of acquiring a degree L₀ of a one-variable irreducible polynomial f(t); a function of selecting a minimum value dₜ of a degree of a coefficient cᵢⱼ(t) when the fibration X(x,y,t) is determined as a two-variable polynomial Σcᵢⱼ(t)xⁱy^{j} of x and y; a function of randomly calculating a constant term r₀₀(t) of the polynomial r(x,y,t) in such a manner that a degree of t becomes equal to or above L₀−dₜ when the three-variable polynomial r(x,y,t) is a polynomial of x and y; a function of randomly calculating a variable term rᵢⱼ(t)xⁱy^{j} other than the constant term r₀₀(t) in the polynomial r(x,y,t) in such a manner that the degree of t becomes equal to or above L₀−dₜ; and a function of adding the constant term r₀₀(t) to the variable term rᵢⱼ(t)xⁱy^{j} to calculate a three-variable polynomial r(x,y,t).

The random value generating unit 24 is controlled by the respective polynomial generating units 23 and 25 and has a function of generating a random value z of a specified bit number and returning this value to the polynomial generating units 23 and 25.

The second polynomial generating unit 25 is controlled by the encrypting unit 16 and has: a function of multiplying the fibration X(x,y,t) by the three-variable polynomial r(x,y,t) to obtain a multiplication result X(x,y,t)r(x,y,t); a function of randomly calculating a constant term s₀₀t) of the polynomial s(x,y,t) in such a manner that a degree of t becomes degₜ s′₀₀(t)-L₀ based on the degree degₜ s′₀₀(t) of t of a constant term s′₀₀(t) in the multiplication result X(x,y,t)r(x,y,t) when the three-variable polynomial s(x,y,t) is determined as a polynomial of x and y; a function of randomly calculating a variable term sᵢⱼ(t)xⁱy^{j} of the polynomial s(x,y,t) in such a manner that the degree of t becomes degₜ s′ᵢⱼ(t)−L₀ based on the variable term sᵢⱼ₍ₜ₎ₓⁱy^{j} other than the constant term s′₀₀(t) in the multiplication result X(x,y,t)r(x,y,t); and a function of adding the constant term s₀₀t) to the variable term sᵢⱼ(t)xⁱy^{j} to generate a three-variable polynomial s(x,y,t).

On the other hand, as shown in FIG. 3, the decryption apparatus 30 includes a parameter storage unit 31, a memory 32, an encrypted text input unit 33, a key input unit 34, a decrypting unit 35, a plaintext development unit 36, a plaintext output unit 37, and an arithmetic unit 40. The arithmetic unit 40 includes a memory 41, a section assignment unit 42, a one-variable polynomial arithmetic unit 43, a one-variable polynomial factorizing unit 44, a one-variable polynomial residue arithmetic unit 45, and a plaintext polynomial inspecting unit 46.

Here, the parameter storage unit 31 is a memory whose information can be read from the decrypting unit 35, and stores a degree L of a one-variable irreducible polynomial f(t) and a characteristic p of a prime field as system parameters.

Data and others under processing from the decrypting unit 35 can be appropriately read from/written in the memory 32.

The encrypted text input unit 33 has a function of transmitting an encrypted text F input from the outside to the decrypting unit 35.

The key input unit 34 has a function of transmitting a public key X(x,y,t) and a private key input from the outside to the decrypting unit 35.

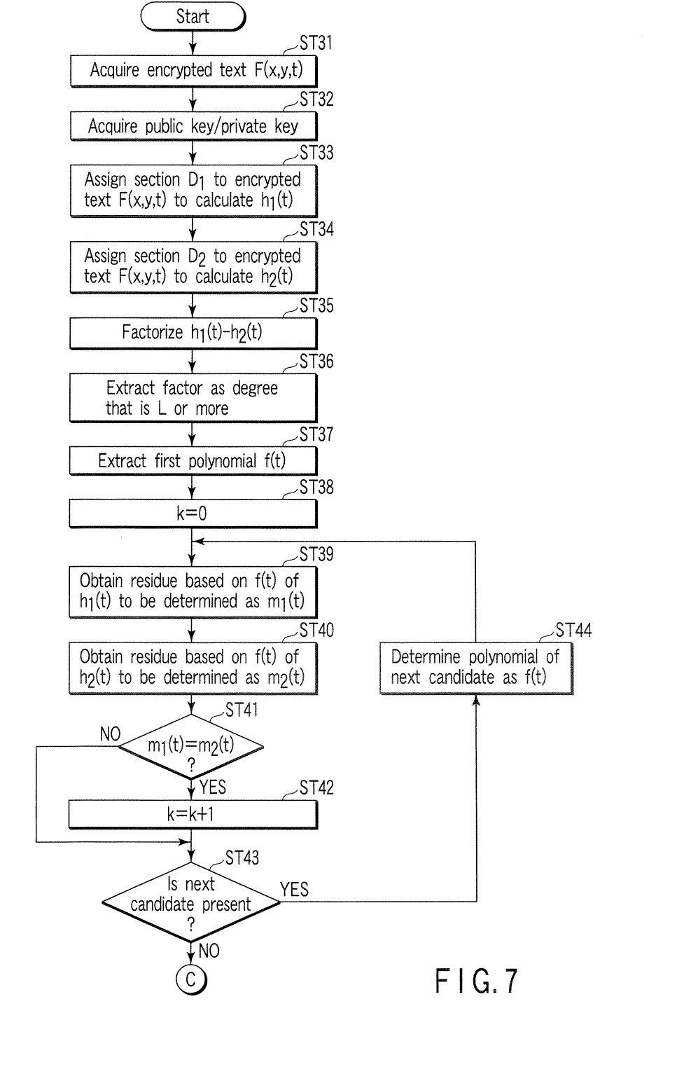

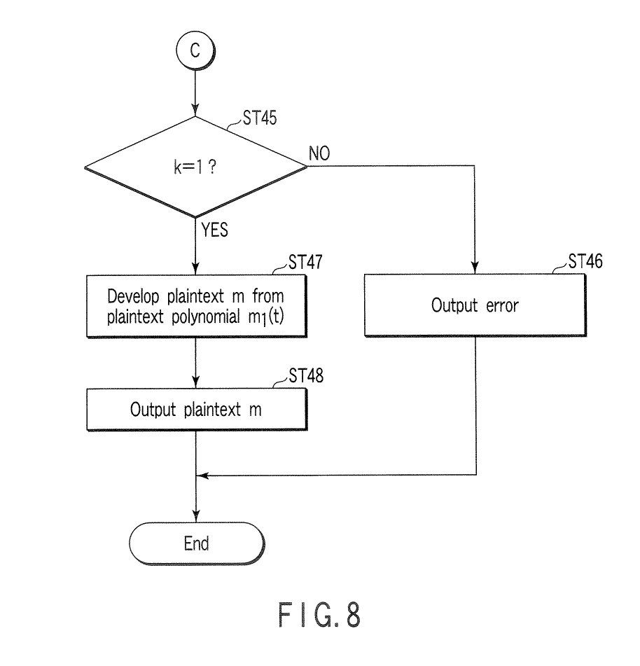

The decrypting unit 35 has a function of controlling the respective units 36 and 40 to 46 on rear stages to execute operations shown in FIGS. 7 and 8.

The plaintext development unit 36 is controlled by the decrypting unit 35 and has a function of developing a message m from a coefficient of a polynomial candidate m₁(t) or m₂(t) when both the candidates match with each other as a result of an inspection.

The plaintext output unit 37 has a function of outputting a plaintext m received from the plaintext development unit 29.

Data and others under processing from the decrypting unit 35 and the respective units 42 to 46 can be appropriately read from/written in the memory 41.

The section assignment unit 42 is controlled by the decrypting unit 35 and has a function of assigning respective sections D₁ and D₂ to an input encrypted text F to generate two one-variable polynomials h₁(t) and h₂(t).

The one-variable polynomial arithmetic unit 43 is controlled by the decrypting unit 35 and has a function of performing subtraction to the respective one-variable polynomials h₁(t) and h₂(t) to obtain a subtraction result {h₁(t)−h₂(t)}.

The one-variable polynomial factorizing unit 44 is controlled by the decrypting unit 35, and has a function of factorizing the subtraction result {h₁(t)−h₂(t)} and a function of extracting all irreducible polynomials f(t) having degrees equal to or above L from the factorization result.

The one-variable polynomial residue arithmetic unit 45 is controlled by the decrypting unit 35, and has a function of dividing the one-variable polynomial h₁(t) by the extracted irreducible polynomial f(t) to obtain the polynomial candidate m₁(t) as a residue and dividing the one-variable polynomial h₂(t) by the irreducible polynomial f(t) to obtain the polynomial candidate m₂(t) as a residue.

The plaintext polynomial inspecting unit 46 is controlled by the decrypting unit 35, and has a function of inspecting whether the polynomial candidates m₁(t) and m₂(t) match with each other and a function of transmitting an inspection result to the decrypting unit 35.

Operations of the encryption apparatus and the decryption apparatus having the above-described configurations will now be explained with reference to flowcharts of FIGS. 4 to 8.

(Encryption Processing: FIGS. 4 to 6)

In the encryption apparatus 10, when a plaintext (a message) m is input from the plaintext input unit 13 (ST1) and a public key X(x,y,t) is input from the public key input unit 14 (ST2), processing is started. Further, a degree L of a one-variable irreducible polynomial f(t) and a characteristic p of a prime field as system parameters are acquired from the system parameter storage unit 11 by the encrypting unit 16 (ST3), and transmitted to the plaintext embedding unit 15.

The plaintext embedding unit 15 divides the plaintext m separately transmitted from the plaintext input unit 13 by L−1 to have a bit length that is one size smaller than a bit length of the characteristic p. For example, in case of p=17, the plaintext m can be divided every four bits. Here, it is assumed that, in the hexadecimal form, the plaintext m is represented as follows:
m=0x315763ef25c04c792ef151
In this case, the plaintext embedding unit 15 divides the plaintext m in the hexadecimal form every four bits, and embeds this plaintext m as a coefficient in a plain polynomial m(t) having a degree L−1 (ST4) as represented by the following expression:
m(t)=3t²¹+t₂₀+5t₁₈+7t₁₈+6t¹⁷+3t¹⁶+15t¹⁵+11t¹⁴+2t¹³+5t¹²+12t¹¹+0t¹⁰+4t⁹+12t⁸+7t⁷+9t⁶+2t⁵+14t⁴+15t³+t²+5t+1

The plaintext embedding unit 15 transmits the plaintext polynomial m(t) to the encrypting unit 16. On the other hand, the public key input unit 14 transmits the public key X(x,y,t) to the encrypting unit 16. The system parameter storage unit 11 transmits the parameters L and p to the encrypting unit 16.

Upon receiving the plaintext polynomial m(t), the parameters L and p, and the public key X(x,y,t), the encrypting unit 16 writes them in the memory 12. Then, the encrypting unit 16 transmits the parameters L and p in the memory 12 to the one-variable irreducible polynomial generating unit 22.

The one-variable irreducible polynomial generating unit 22 randomly generates the one-variable irreducible polynomial f(t) having a degree equal to or above L (ST5), and returns the obtained one-variable irreducible polynomial f(t) to the encrypting unit 16. Here, the irreducible polynomial is generated by randomly generating a polynomial having a degree equal to or above L and repeating a judgment of reducibility on Fₚ until the one-variable polynomial becomes the irreducible polynomial.

The encrypting unit 16 stores the one-variable irreducible polynomial f(t) in the memory 12, and then transmits p, L, f(t), and X(x,y,t) to the first polynomial generating unit 23. The first polynomial generating unit 23 executes the following processing to generate a three-variable polynomial r(x,y,t).

First, the first polynomial generating unit 23 obtains a degree L₀ of the received one-variable irreducible polynomial f(t) (ST6). In regard to the degree L₀, obtaining a maximum degree can suffice. Although specific processing of obtaining this degree differs depending on a data structure, persons skilled in the art can readily realize this processing. Then, in regard to the following expression when an algebraic surface X(x,y,t) as the public key is regarded as a polynomial of x and y, a minimum value dₜ of a degree of a coefficient cᵢⱼ(t) is obtained (ST7):

$${\sum }_{i , j} {c}_{ij} ( t ) {x}^{i} {y}^{j}$$

As processing of obtaining the minimum value dₜ of the degree, it is good enough to execute processing of executing the coefficient cᵢⱼ(t), processing of obtaining a degree of t from the coefficient cᵢⱼ(t), and processing of selecting the minimum value dₜ of the degree of t when like terms of the algebraic surface X(x,y,t) are organized in regard to x and y to acquire the following expression:

$${\sum }_{i , j} {c}_{ij} ( t ) {x}^{i} {y}^{j}$$

It is to be noted that executing the same technique as the technique of acquiring the degree of f(t) can suffice as processing of obtaining the degree of t.

Then, the first polynomial generating unit 23 determines a monomial rᵢⱼ(t)xⁱy^{j} required to generate each term when r(x,y,t) is regarded as a polynomial of x and y. First, a constant term r₀₀(t) is determined as follows (ST8 to ST10). That is, a value Lo-dₜ+1 is calculated (ST8), and a value d₀₀ equal to or above the obtained value L₀−dₜ+1 is transmitted to the random value generating unit 24. The random value generating unit 24 generates a random value having d₀₀ bits (ST9), and returns this random value to the first polynomial generating unit 23. Here, in order to obtain the value d₀₀ equal to or above L₀−dₜ+1, there is, e.g., a method of transmitting a natural number 3 to the random value generating unit 24 to produce numbers 0 to 7 and adding the produced values to L₀−dₜ+1.

Upon receiving the random value, the first polynomial generating unit 23 forcibly changes the most significant bit in the random value to 1 in order to set a coefficient of the maximum degree to 1. Then, the first polynomial generating unit 23 determines a value zᵢ of an ith bit in the random value to a coefficient of tⁱ⁻¹, generates a polynomial as represented by the following expression, and determines this polynomial as a constant term r₀₀(t) (ST10):

$$\begin{matrix}{r}_{00} ( t ) = {\sum }_{i = 1}^{{d}_{00}} {z}_{i} {t }^{i - 1} \\ = {z}_{{d}_{00}} {t}^{{d}_{00} - 1} + {z}_{{d}_{00} - 1} {t}^{{d}_{00} - 2} + ⋯ + {z}_{2} t + {z}_{1}\end{matrix}$$

A degree of the constant term r₀₀(t) is equal to or above L₀−dₜ. That is because, when X(x,y,t) having the minimum degree dₜ is multiplied by r(x,y,t), the minimum degree concerning the obtained polynomial X(x,y,t)r(x,y,t) is set to L₀. This is also applied to a degree of t of a variable term rᵢⱼ(t)xⁱy^{j} other than the constant term.

Then, the variable term rᵢⱼ(t)xⁱy^{j} other than the constant term is determined as follows (ST11 to ST16). It is to be noted that a term except for the constant term that is adopted as a non-zero term is previously determined in the system. In this example, it is determined that a term having e as an upper limit of a degree concerning x and y is adopted as a non-zero term.

The first polynomial generating unit 23 reads the upper limit e of the degree from the memory 21 and transmits it to the random value generating unit 24. The random value generating unit 24 produces values i and j equal to or below the upper limit e (ST11), and judges whether the values i and j are values generated before (ST12). This judgment can be made by, e.g., making reference to a list in the memory 21 in which the values i and j produced in the past are written and confirming that the currently generated values i and j are not present in this list. If these values are the values generated in the past as a result of judgment at the step ST12, the control returns to the step ST11. On the other hand, if these values are not such values as a result of the judgment at the step ST12, the generated values i and j are determined as degrees i and j, thereby determining a variable xⁱy^{j} of the term. Additionally, if these values are not the values produced in the past, the currently generated values i and j are added to the list.

Further, a coefficient rᵢⱼ(t) of the determined term is generated by the same processing as that in the steps ST9 to ST10 of producing the constant term r₀₀(t) as represented by the following expression (ST13 to ST14). However, in Expression 12, dᵢⱼ is a degree of rᵢⱼ(t) and it is a value equal to or above L₀−dₜ+1, like d₀₀.

$${r}_{ij} ( t ) = {\sum }_{i = 1}^{{d}_{ij}} {z}_{i} {t}^{i - 1}$$

Then, a variable term rᵢⱼ(t)xⁱy^{j} is generated based on the coefficient rᵢⱼ(t) and the variable xⁱy^{j} (ST15). Further, the number of non-zero terms is likewise determined based on a parameter w indicative of the number of non-zero terms stored in the memory 21. That is, the first polynomial generating unit 23 judges whether a total of w non-zero terms have been generated (ST16) after the step ST15. If the w non-zero terms have not been generated, the control returns to the step ST11. Here, since the encrypted text becomes large in proportion to the number w of non-zero terms, the optimum number w that can assure security must be determined at a design stage.

On the other hand, if it is determined that the w non-zero terms have been generated as a result of the judgment at the step ST16, the first polynomial generating unit 23 adds the constant term r₀₀(t) to all the variable terms rᵢⱼ(t)xⁱy^{j} to produce a three-variable polynomial r(x,y,t) (ST17). The first polynomial generating unit 23 transmits the three-variable polynomial r(x,y,t) to the encrypting unit 16 to terminate the processing. The encrypting unit 16 writes and saves the three-variable polynomial r(x,y,t) in the memory 12.

When explaining a coefficient of the three-variable polynomial below, a target is a term cᵢⱼ(t)xⁱy^{j} when considering a polynomial Σcᵢⱼ(t)xⁱy^{j} of x and y alone unless stated. That is, a coefficient of the term cᵢⱼ(t)xⁱy^{j} is cᵢⱼ(t), and a degree of the coefficient is a degree concerning t of cᵢⱼ(t)xⁱy^{j}. This explanation is not restricted to “cᵢⱼ(t)xⁱy^{j}”, and is likewise applied to “rᵢⱼ(t)xⁱy^{j}”, “sᵢⱼ(t)xⁱy^{j}” and others.

Subsequently, the encrypting unit 16 calculates s′(x,y,t)=X(x,y,t)r(x,y,t) based on r(x,y,t) in the memory 12 (ST18), and transmits X(x,y,t)r(x,y,t), p and, L₀ to the second polynomial generating unit 25.

The second polynomial generating unit 25 determines a polynomial s(x,y,t) as follows (ST19 to ST27).

First, coefficients of respective terms included in the calculated X(x,y,t)r(x,y,t) are randomly determined in such a manner that a degree of each coefficient becomes a value obtained by subtracting L₀ from a degree of a corresponding term in X(x,y,t)r(x,y,t). Here, each coefficient is determined by the same processing performed when generating each coefficient in r(x,y,t). This will be described below for confirmation.

The second polynomial generating unit 25 determines a monomial sᵢⱼ(t)xⁱy^{j} that is used to produce each term in the three-variable polynomial s(x,y,t) based on a monomial sᵢⱼ(t)xⁱy^{j} that is used to generate each term when X(x,y,t) r(x,y,t)=s′(x,y,t) is regarded as a polynomial of x and y. First, a constant term s₀₀t) is determined as follows (ST19 to ST21). That is, a value degₜ s′₀₀(t)−L₀+1 is calculated from a degree degₜ s′₀₀(t) in a constant term s′₀₀(t) in s′ (x,y,t) (ST19), and the obtained value degₜ s′₀₀(t)−L₀+1 is transmitted to the random value generating unit 24. The random value generating unit 24 generates a random value having degₜ s′₀₀(t)-−L₀+1 bits (ST20), and returns this random value to the second polynomial generating unit 25.

Upon receiving the random value, the second polynomial generating unit 25 forcibly changes the most significant bit in the random value to 1 in order to set a coefficient having the maximum degree to 1. Then, the second polynomial generating unit 25 determines a value zⱼ of a ith bit in the random value as a coefficient of tⁱ⁻¹, generates a polynomial as represented by the following expression, and determines this polynomial as a constant term s₀₀t) (ST21):

$${s}_{00} ( t ) = {\sum }_{i = 1}^{{deg}_{t} {s}_{00}^{′} ( t ) - {L}_{0} + 1} {z}_{i} {t}^{i - 1}$$

A degree of the constant term s₀₀t) is degₜ s′₀₀(t)−L₀. That is because a degree concerning t in a polynomial f(t)s(x,y,t) obtained when multiplying s(x,y,t) by f(t) of the minimum degree L₀ must be matched with the degree degₜ s′₀₀(t) concerning t in X(x,y,t)r(x,y,t). This is also applied to a degree of t in a variable term sᵢⱼ(t)xⁱy^{j} other than the constant term.

Subsequently, a term sᵢⱼ(t)xⁱy^{j} other than the constant term is determined as follows (ST22 to ST26). That is, a value degₜ s′ij(t)−L₀+1 is calculated from the degree degₜ s′ᵢⱼ(t) of t in the coefficient s′ᵢⱼ(t) of the variable term s′ᵢⱼ(t)xⁱy^{j} (ST22), and the obtained value degₜ s′ᵢⱼ(t)−L₀+1 is transmitted to the random value generating unit 24. The random value generating unit 24 generates a random value having degₜ s′ᵢⱼ(t)−L₀+1 bits (ST23), and returns this random value to the second polynomial generating unit 25.

Upon receiving the random value, the second polynomial generating unit 25 likewise forcibly changes the most significant bit in the random value to 1. Then, the second polynomial generating unit 25 determines a value zᵢ of an ith bit in the random value as a coefficient of tⁱ⁻¹, generates a polynomial as represented by the following expression, and determines this polynomial as a coefficient sᵢⱼ(t) of a variable term (ST24). It is to be noted that the coefficient sᵢⱼ(t) of the variable term is generated by the same processing as that of producing the constant term.

$${s}_{ij} ( t ) = {\sum }_{i = 1}^{{deg}_{t} {s}_{00}^{′} ( t ) - {L}_{0} + 1} {z}_{i} {t}^{i - 1}$$

Subsequently, the second polynomial generating portion 25 generates the variable term sᵢⱼ(t)xⁱy^{j} based on the coefficient sᵢⱼ(t) and the variable xⁱy^{j} (ST25). This generation of the variable term sᵢⱼ(t)xⁱy^{j} is sequentially executed in accordance with each variable term s′ᵢⱼ(t)xⁱy^{j} in s′(x,y,t). After the step ST25, the second polynomial generating unit 25 judges whether all terms corresponding to respective terms in r(x,y,t)X(x,y,t) have been produced (ST26). If not, the control returns to the step ST22.

On the other hand, if it is determined that all terms have been generated as a result of the judgment at the step ST26, the second polynomial generating unit 25 adds the constant term s₀₀t) to all the variable terms sᵢⱼ(t)xⁱy^{j} to generate a three-variable polynomial s(x,y,t) (ST27). The second polynomial generating unit 25 transmits the three-variable polynomial s(x,y,t) to the encrypting unit 16 to terminate the processing. The encrypting unit 16 writes and saves the three-variable polynomial s(x,y,t) in the memory 12.

The encrypting unit 16 utilizes m(t), f(t), s(x,y,t), and r(x,y,t) obtained by the above-explained processing and the algebraic surface X(x,y,t) as the public key to calculate and develop the encrypted text F(x,y,t) in accordance with Expression (3) (ST28). The encrypting unit 16 outputs this encrypted text F(x,y,t) from the encrypted text output unit 17 (ST29) (the encrypting unit 16 modifies the encrypted text F(x,y,t) in accordance with a predetermined format if required), thereby terminating the encryption processing.

(Decryption Processing: FIGS. 7 and 8)

The decryption apparatus 30 acquires the encrypted text F(x,y,t) from the encrypted text input unit 33 (ST31), obtains the public key X(x,y,t) and a private key from the key input unit 34 (ST32), and acquires p and L from the parameter storage unit 31 to start decryption processing. Here, the private key is two sections D₁ and D₂. The acquired encrypted text, key information and others are transmitted to the decrypting unit 35. The decrypting unit 35 writes and saves the encrypted text, the key information and others in the memory 32.

The decrypting unit 35 transmits the encrypted text F(x,y,t) and the second D₁ in the memory 32 to the section assignment unit 42. The section assignment unit 42 assigns D₁ to F(x,y,t), and utilizes the one-variable polynomial arithmetic unit 43 as required to obtain h₁(t). Here, the one-variable polynomial arithmetic unit 43 performs addition/subtraction/multiplication/division with respect to a one-variable polynomial. The obtained h₁(t) is transmitted to the decrypting unit 35 from the section assignment unit 42.

Furthermore, likewise, the decrypting unit 35 transmits the encrypted text F(x,y,t) and the section D₂ in the memory 32 to the section assignment unit 42. The section assignment unit 42 assigns D₂ to F(x,y,t) to obtain h₂(t). The obtained h₂(t) is transmitted from the section assignment unit 42 to the decrypting unit 35.

The decrypting unit 35 transmits h₁(t) and h₂(t) to the one-variable polynomial arithmetic unit 43 to subtract them. The one-variable polynomial arithmetic unit 43 transmits a subtraction result {h₁(t)−h₂(t)} to the decrypting unit 35.

The decrypting unit 35 transmits the subtraction result {h1(t)−h2(t)} to the one-variable polynomial factorizing unit 44 to factorize this result (ST35). When the one-variable polynomial factorizing unit 44 obtains an irreducible polynomial f(t) as a factor that is not lower than a degree L in the factorization result (ST36), it transmits this irreducible polynomial f(t) to the decrypting unit 35. It is to be noted that a plurality of candidates for the one-variable irreducible polynomial f(t) may possibly appear in this decryption processing, and hence the following processing is executed to select the correct f(t). First, the decrypting unit 35 extracts one candidate for f(t) (ST37), and sets a counter value k of the candidate for the correct f(t) to zero (ST38). It is to be noted that the counter value k is stored in the memory 41.

The decrypting unit 35 utilizes the one-variable polynomial residue arithmetic unit 45 to divide h₁(t) by f(t), and obtains a plaintext polynomial m₁(t) as a residue (ST39). Likewise, the decrypting unit 35 utilizes the one-variable polynomial residue arithmetic unit 45 to divide h₂(t) by f(t), and obtains a plaintext polynomial m₂(t) as a residue (ST40).

Then, the decrypting unit 35 transmits these expressions m₁(t) and m₂(t) to the plaintext polynomial inspecting unit 46. The plaintext polynomial inspecting unit 46 judges whether m₁(t) and m₂(t) are equal to each other (ST41), and transmits a judgment result to the decrypting unit 35. If the judgment result is indicative of equality, the decrypting unit 35 stores a polynomial m₁(t)=m₂(t) in the memory 41, increments the counter value k by one (ST42), and judges whether the next candidate is present (ST43). If the next candidate is present, the decrypting unit 35 sets a polynomial of the next candidate as f(t) (ST44), and repeats the processing at the steps ST39 to ST43.

If the judgment result at the step ST41 is not indicative of equality, this means that the f(t) candidate is an error, and hence the decrypting unit 35 advances to a step ST43 to perform the same operation with respect to the next candidate f(t).

On the other hand, if it is determined that the next candidate is not present as a result of the judgment at the step ST43, the decrypting unit 35 judges whether the counter value k is k=1 (whether k=0 or k≦2) (ST45).

If it is determined that k=0 or k≦2 as a result of the judgment at the step ST45, this means that there is no correct candidate at all or two or more correct candidates are present. Therefore, this is a failure in the decryption processing, since an error is output to terminate the decryption processing (ST46).

If it is determined that k=1 as a result of the judgment at the step ST45, this means that just one correct f(t) has been found. Therefore, the decrypting unit 35 transmits m(t) stored in the memory 41 as a plaintext polynomial to the plaintext development unit 36. The plaintext development unit 36 develops the plaintext polynomial m(t) (ST47), and transmits an obtained plaintext m to the plaintext output unit 37. The plaintext output unit 37 outputs this plaintext m (ST48) to terminate the decryption processing.

As explained above, according to this embodiment, the two multiplication results X(x,y,t)r(x,y,t) and f(t)s(x,y,t) included in the encrypted text F are constituted of like terms of the variable xⁱy^{j} when they are regarded as polynomials of x and y. As a result, even if a technique of analyzing a term that is present in one multiplication result X(x,y,t)r(x,y,t) but absent in the other multiplication result f(t)s(x,y,t) is used, the respective terms cannot be discriminated, and a part of r(x,y,t) does not leak.

Therefore, it is possible to avoid leakage of a randomized polynomial in the public key cryptography using the algebraic surface.

<Variation of First Embodiment>

A first variation is a variation concerning a modification of Expression (3) used for encryption processing. Even if Expression (3) is modified as follows, encryption/decryption is likewise possible, and security can be likewise verified:
F(x,y,t)=m(t)−f(t)s(x,y,t)−X(x,y,t)r(x,y,t)
The expression for encryption can be modified in this manner without departing from the scope of the present invention, and decryption processing can be thereby sufficiently modified.

A second variation is a mode of embedding a plaintext m in a one-variable irreducible polynomial f(t). Although the mode of randomly generating f(t) has been explained in the foregoing embodiment, the fact that obtaining f(t) without a private key is difficult is also one of properties of the public key cryptography according to the present invention. Therefore, the mode of embedding plaintext information in f(t) can be realized.

When embedding a plaintext m in f(t), a plaintext having a larger size can be encrypted. However, since an embedding result f(t) must be determined as an irreducible polynomial, it is necessary to predetermine that a random coefficient is included in specific coefficients. Since many irreducible polynomials are present, even if the plaintext m is embedded in some coefficients, irreducible polynomials can be obtained in most cases. Even if the irreducible polynomial cannot be obtained, increasing a degree of f(t) can widen a search range. Even if such a modification is carried out, the same security can be realized.

Further, in regard to the decryption processing, both m(t) and f(t) are developed, and a part of the plaintext m is taken out from some of predetermined coefficients in f(t), thereby enabling decryption.

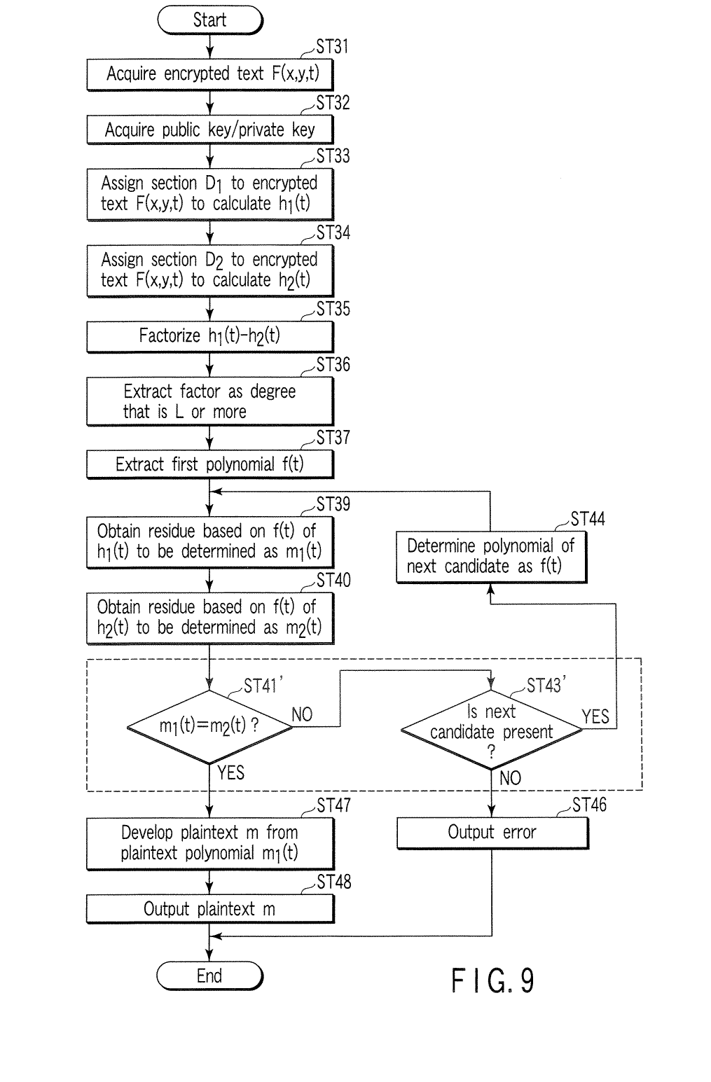

A third variation is a variation concerning the decryption processing alone. As indicated at a step ST41′ in FIG. 9, when f(t) that achieves m₁(t)=m₂(t) is found, the decrypting unit 35 transmits m₁(t) to the plaintext development unit 36. Furthermore, when m₁(t)=m₂(t) is not attained, the decrypting unit 35 judges whether the next candidate is present (ST43′). If the next candidate is not present, an error is output to terminate the processing. According to the third variation, since targets of the judgment on m₁(t)=m₂(t) are reduced, a part of the decryption processing (ST38, ST42, and ST45) can be deleted. Moreover, when m₁(t)=m₂(t) is achieved, the same processing concerning the remaining candidates for f(t) is no longer necessary.

Additionally, in the decryption processing, in a case where h₁(t)−h₂(t) is factorized from Expression (4) to obtain a factor having a degree that is L or more, when a plurality of candidates for f(t) are present, the two residues m₁(t) and m₂(t) are compared in regard to all the candidates, and the fact that one candidate alone has the residues matching with each other is confirmed to determine a plaintext polynomial in this embodiment. However, (as explained in this embodiment), it can be considered that a coincidence of two or more candidates as different plaintext polynomials is a negligibly small probability. Therefore, if there is a candidate having m₁(t) and m₂(t) matching with each other, the probability that regarding this candidate as f(t) and executing the plaintext polynomial processing with respect to corresponding m₁(t) results in an erroneous plaintext is negligibly small. Further, according to this structure, a part of the decryption processing can be deleted, and the same processing is no longer necessary in regard to other candidates for f(t) (which do not lead to the correct f(t) except for a negligible probability). Therefore, the number of times of plaintext polynomial inspection processing can be averaged to be reduced to approximately ½.

### SECOND EMBODIMENT

Outline

A second embodiment according to the present invention will now be described. Like the first embodiment, system parameters according to this embodiment are as follows:

1. a characteristic p of a prime field; and

2. a degree L of a one-variable irreducible polynomial f(t) in Fₚ.

Furthermore, a public key is:

1. a fibration on an algebraic surface X in Fₚ:
X(x,y,t)
A private key is:
1. a section on the algebraic surface X in Fₚ:
D:(x,y,t)=(uₓ(t),u_{y}(t),t)
The second embodiment is largely different from the first embodiment in that the number of sections serving as private keys is one. Therefore, the second embodiment has an effect that a size of the private key is decreased and a freedom degree in key generation is increased.

(Encryption Processing)

An outline of encryption processing according to this embodiment will now be explained. Although the encryption processing is substantially the same as that according to the first embodiment, two encrypted texts F₁(x,y,t) and F₂(x,y,t) are generated in the second embodiment, which differs from the first embodiment in which one encrypted text F(x,y,t) is produced.

Specifically, according to the second embodiment, common f(t) is used to produce two different random sets of three-variable polynomials (s₁(x,y,t), s₂(x,y,t)) and (r₁(x,y,t), r₂(x,y,t)) by the same means as that in the first embodiment, thereby generating two encrypted texts F₁(x,y,t) and F₂(x,y,t) as represented by the following expression:
F₁(x,y,t)=m(t)+f(t)s₁(x,y,t)+X(x,y,t)r₁(x,y,t)
F₂(x,y,t)=m(t)+f(t)s₂(x,y,t)+X(x,y,t)r₂(x,y,t)

Upon receiving the encrypted texts F₁(x,y,t) and F₂(x,y,t), a receiver utilizes his/her private key D to perform decryption as follows. First, the section D is assigned to the encrypted texts F₁(x,y,t) and F₂(x,y,t) to obtain the following two expressions h₁(t) and h₂(t) based on the same concept as that of the first embodiment:
h₁(t)=F₁(uₓ(t),u_{y}(t),t)=m(t)+f(t)s₁(uₓ(t),u_{y}(t),t)
h₂(t)=F₂(uₓ(t),u_{y}(t),t)=m(t)+f(t)s₂(uₓ(t),u_{y}(t),t)

Then, the two expressions are subjected to subtraction to calculate the following expression h₁(t)−h₂(t):
h₁(t)−h₂(t)=f(t){s₁(uₓ(t),u_{y}(t),t)−s₂(uₓ(t),u_{y}(t),t)}

Then, h₁(t)−h₂(t) is factorized to determine a factor having the maximum degree as f(t). The subsequent processing is the same as that in the first embodiment, thereby omitting an explanation thereof.

(Key Generation Processing)

At last, a key generation method according to this embodiment will be explained. Key generation according to this embodiment is executed by randomly selecting a section D and calculating a corresponding fibration like the first embodiment.

However, it is good enough to constitute this embodiment to satisfy one section as different from the first embodiment, and a key having a higher degree of freedom can be readily generated than the first embodiment.

Here, the key generation method will be explained while taking the following algebraic surface of algebraic surfaces as an example:
Xt:y³=x³+ξ₁(t)x²y+ξ²(t)xy²+ξ³(t)y+ξ₄(t)

Here, ξ₁(t), ξ₂(t), ξ₃(t), and ξ₄(t) are one-variable polynomials. First, a characteristic p of a prime field is determined. At this time, even if p is small, no problem occurs in security. Meanwhile, the section D is determined as follows:
D:(x,y,t)=(uₓ(t),u_{y}(t),t)
The one-variable polynomials ξ₁(t), ξ₂(t), and ξ₃(t) other than a constant term are randomly determined, and ξ₁(t), ξ₂(t), and ξ₃(t) and the section D are assigned to the algebraic surface Xt to obtain ξ₄(t) based on the following expression:
ξ₄(t)=u_{y}(t)²−uₓ(t)³−ξ₁(t)uₓ(t)²u_{y}(t)−ξ₂(t)uₓ(t)u_{y}(t)²−ξ₃(t)u_{y}(t) (11)

Furthermore, the first to the third variations of the first embodiment are likewise achieved in this embodiment.

(Examination of Security)

Security of the thus configured public key cryptography according to this embodiment will now be considered. Basically, examination of security in the first embodiment is examination of security in this embodiment as it is. A difference from the first embodiment lies in that two encrypted texts are present, and security about this point will be considered. When subtraction of the encrypted texts F₁(x,y,t) and F₂(x,y,t) is executed, the following expression can be obtained:
F₁(x, y, t)−F₂(x, y, t)=f(t)(s₁(x, y, t)−s₂(x, y, t))+X(x, y, t)(r₁(x, y, t)−r₂(x, y, t))

In this expression, although the plaintext polynomial m(t) is deleted, s₁(x,y,t)≠s₂(x,y,t) or r₁(x,y,t)≠r₂(x,y,t) is attained. Here, since factorization of the three-variable polynomial is not necessarily unique, almost no information can be acquired from its factors and others.

(Specific Configuration of Second Embodiment)

The second embodiment according to the present invention will now be concretely explained. Since an encryption apparatus 10 and a decryption apparatus 30 have the same hardware configurations as those in the first embodiment, the second embodiment will be explained with reference to FIGS. 2 and 3.

This embodiment is a modification of the first embodiment, and is different from the first embodiment in that one section D and two encrypted texts F₁(x,y,t) and F₂(x,y,t) are used. Thus, differences from the first embodiment will be mainly explained below.

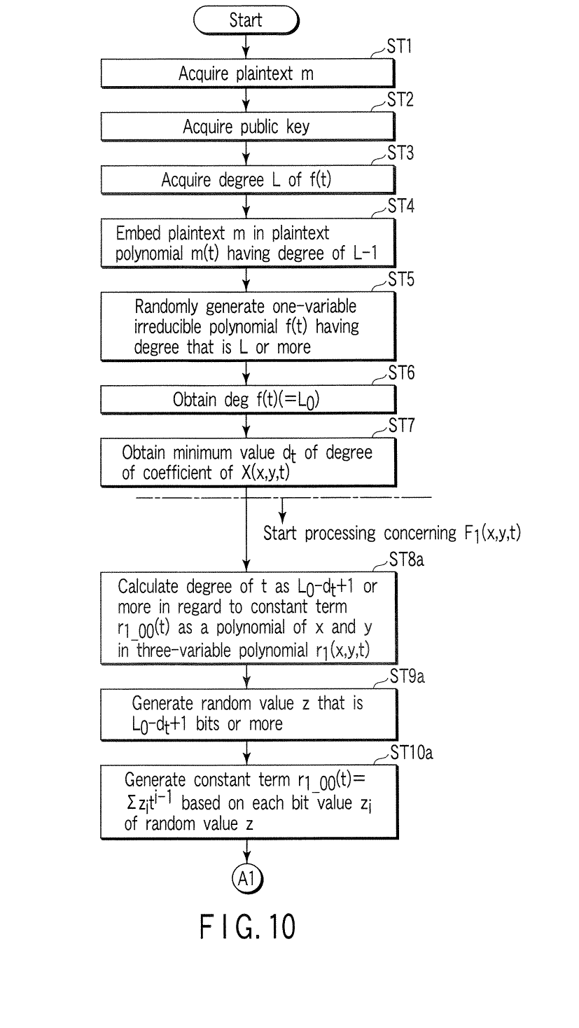

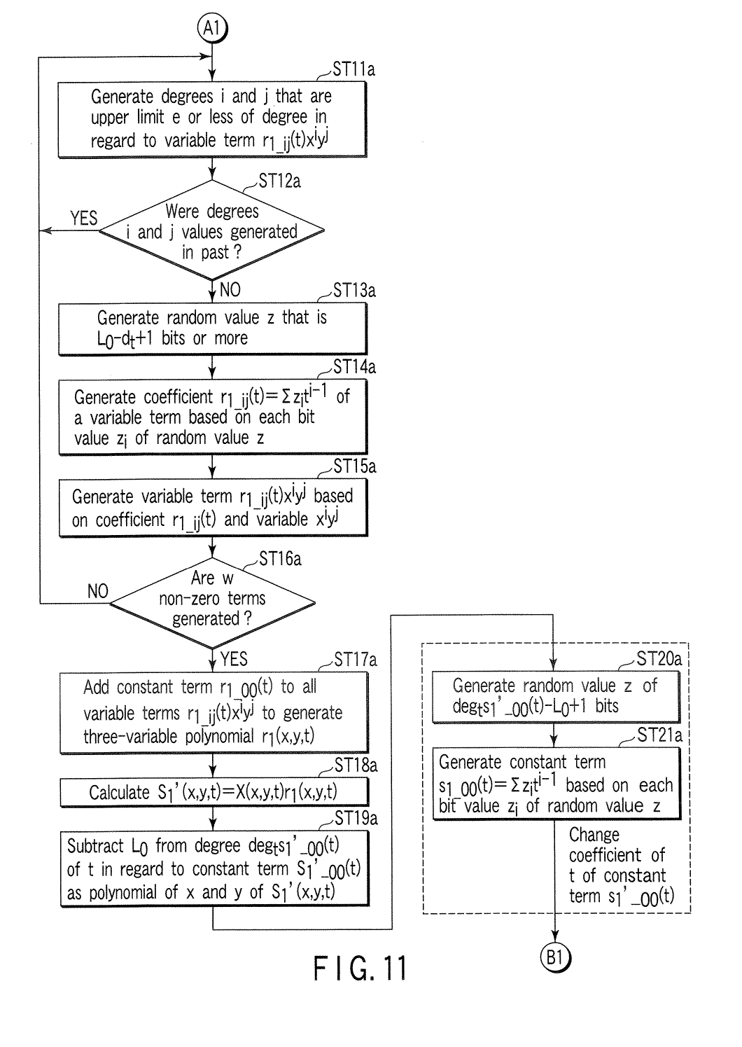

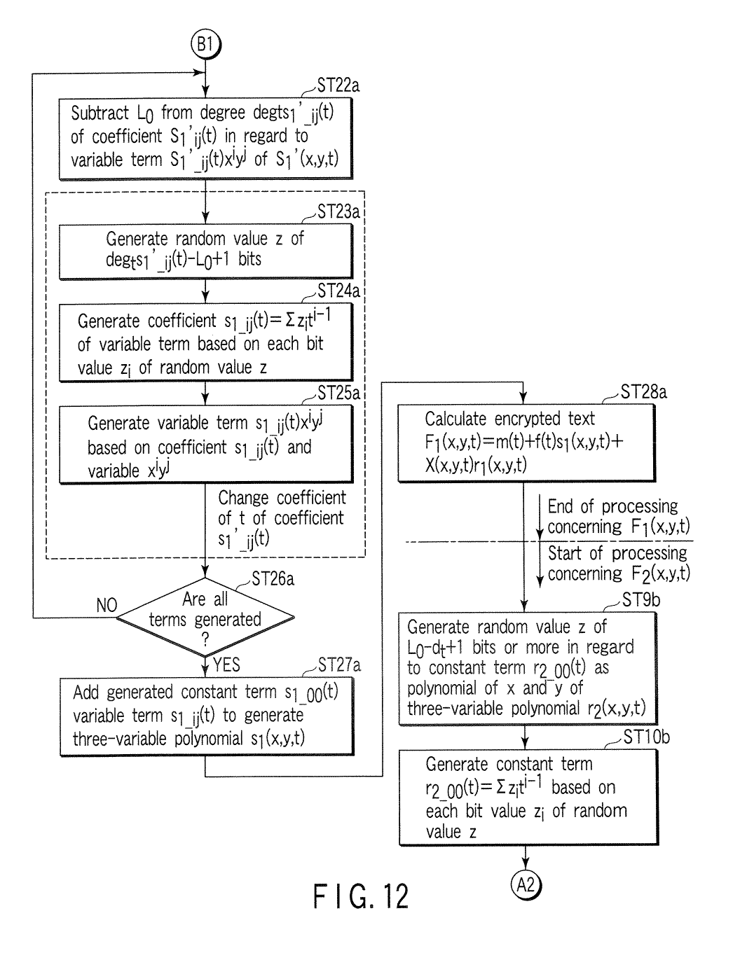

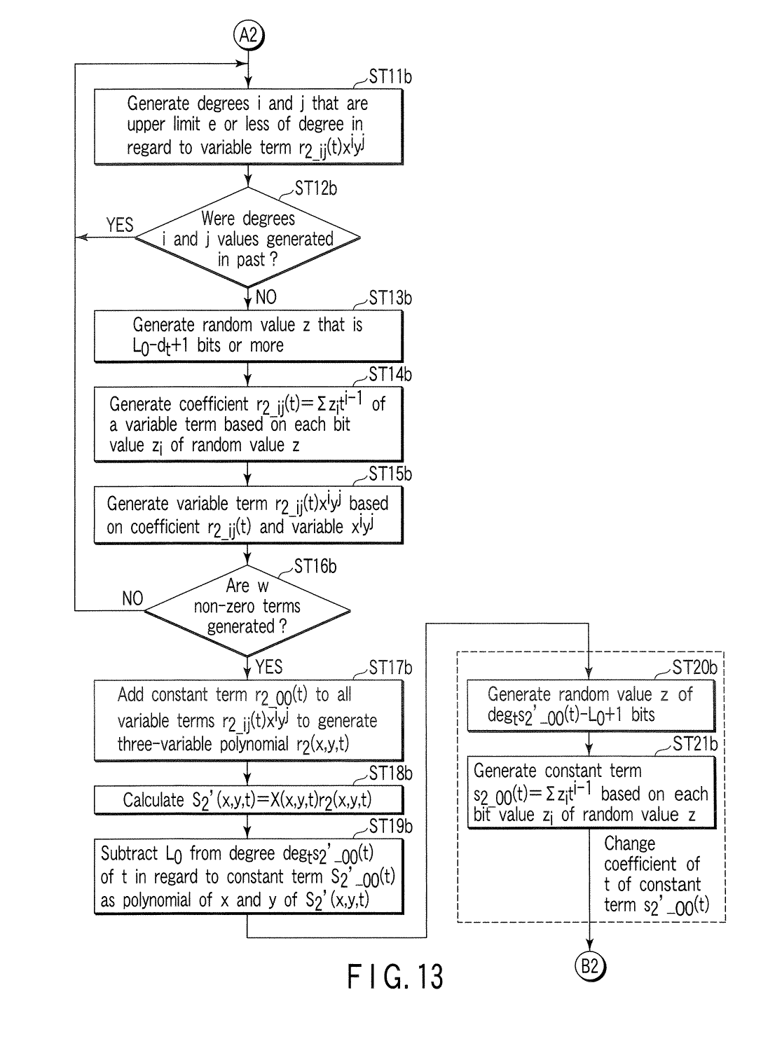

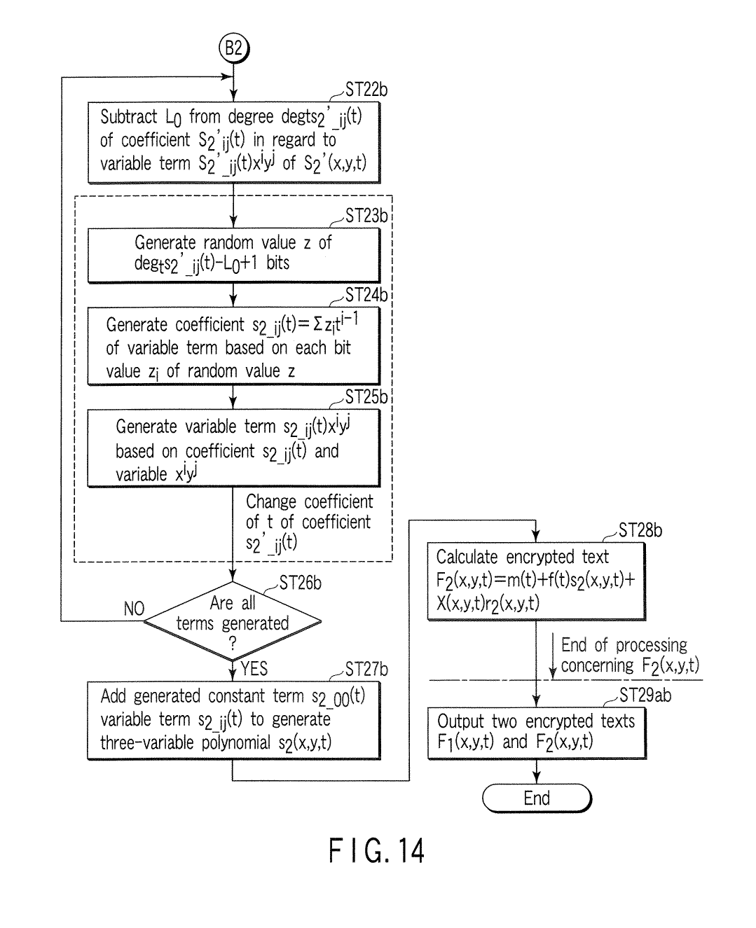

Specifically, an encrypting unit 16 controls respective units 17 and 20 to 25 on rear stages to execute operations depicted in FIGS. 10 to 14 based on a plaintext polynomial m(t) received from a plaintext embedding unit 13 and a public key X(x,y,t) received from a public key input unit 14. In particular, the encrypting unit 16 has a function of generating an encrypted text F₁=Eₚₖ(m,s₁,r₁,f,X)=F₁(x,y,t) from the plaintext polynomial m(t) by processing of executing addition or subtraction using “a multiplication result X(x,y,t)r₁(x,y,t) of a fibration X(x,y,t) and a three-variable polynomial r₁(x,y,t)” and “a multiplication result f(t)s₁(x,y,t) of a random one-variable irreducible polynomial f(t) having a degree that is L or more and a three-variable polynomial s₁(x,y,t)” constituted of like terms of a variable xⁱy^{j} (where i and j are degrees not smaller than zero) when the plaintext polynomial m(t) is regarded as a polynomial of x and y.

Furthermore, the encrypting unit 16 also has a function of generating an encrypted text F₂=Eₚₖ(m,s₂,r₂,f,X)=F₂(x,y,t) from the plaintext polynomial m(t) by processing of executing addition or subtraction using “a multiplication result X(x,y,t)r₂(x,y,t) of the fibration X(x,y,t) and a three-variable polynomial r₂(x,y,t) (≠r₁(x,y,t))” and “a multiplication result f(t)s₂(x,y,t) of a random one-variable irreducible polynomial f(t) having a degree that is L or more and a three-variable polynomial s₂(x,y,t)” constituted of like terms of a variable xⁱy^{j} (where i and j are degrees not smaller than zero) when the plaintext polynomial m(t) is likewise regarded as a polynomial of x and y.

An encrypted text input unit 33 has a function of transmitting encrypted texts F₁(x,y,t) and F₂(x,y,t) input from the outside to a decrypting unit 35.

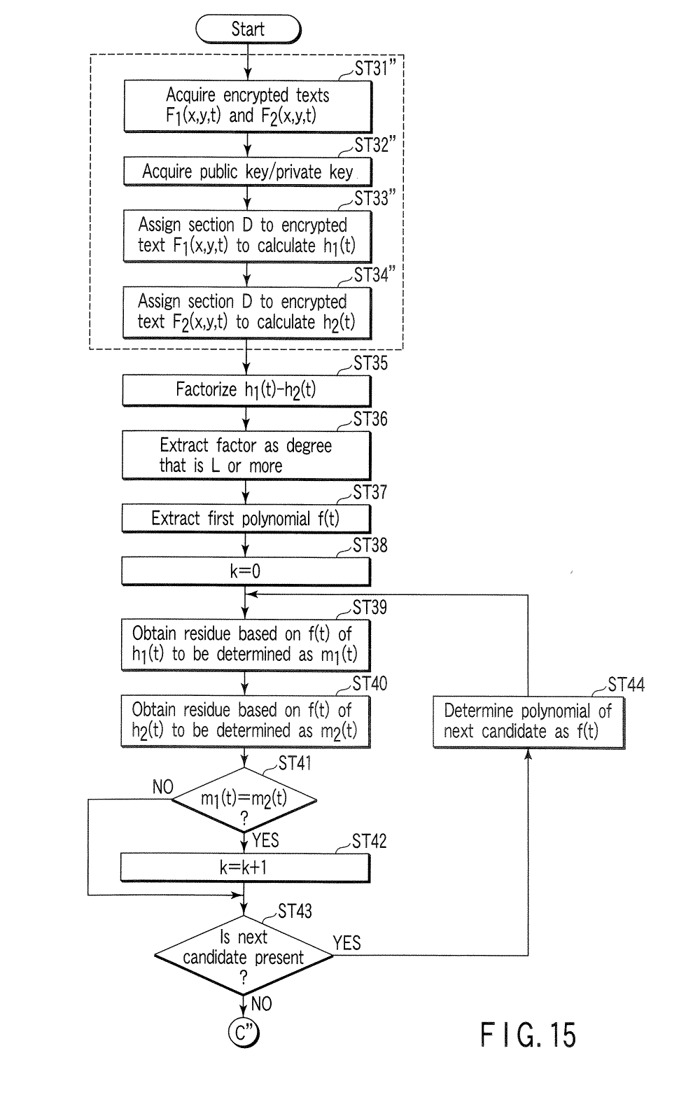

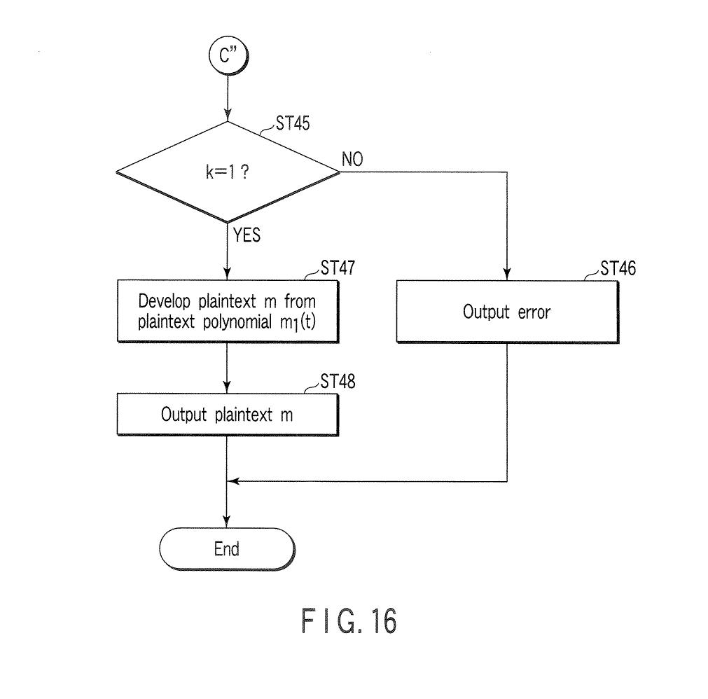

The decrypting unit 35 has a function of controlling respective units 36 and 40 to 46 on rear stages to execute operations depicted in FIGS. 15 to 16.

A section assignment unit 42 is controlled by the decrypting unit 35 and has a function of assigning a section D to the input encrypted texts F₁(x,y,t) and F₂(x,y,t) to generate two one-variable polynomials h₁(t) and h₂(t).

Operations of the thus configured encryption apparatus and decryption apparatus will now be described with reference to flowcharts of FIGS. 10 to 16.

(Encryption Processing: FIGS. 10 to 14)

The encryption apparatus 10 executes steps ST1 to ST7 to obtain a minimum value dₜ of a degree of t in a coefficient cᵢⱼ(t) of the public key X(x,y,t) as explained above.

Subsequently, the encryption apparatus 10 generates a three-variable polynomial r₁(x,y,t) (ST8a to ST17a) by the same processing as the steps ST8 to ST17, and produces a three-variable polynomial s₁(x,y,t) (ST18a to ST27a) by the same processing as the steps ST18 to ST27. Furthermore, in the encryption apparatus 10, the encrypting unit 16 generates a first encrypted text F₁(x,y,t) by the same processing as the step ST28 based on m(t), f(t), s₁(x,y,t), r₁(x,y,t), and X(x,y,t) (ST28a).

Subsequently, the encryption apparatus 10 generates a three-variable polynomial r₂(x,y,t) (ST9b to ST17b) by the same processing as the steps ST9 to ST17, and produces a three-variable polynomial s₂(x,y,t) (ST27b) by the same processing as the steps ST18 to ST27. Thereafter, in the encryption apparatus 10, the encrypting unit 16 generates a second encrypted text F₂(x,y,t) by the same processing as the step ST28 based on m(t), f(t), s₂(x,y,t), r₂(x,y,t), and X(x,y,t).

The encrypting unit 16 outputs these encrypted texts F₁(x,y,t) and F₂(x,y,t) from the encrypted text output unit 17 (the encrypting unit 16 modifies these encrypted texts F₁(x,y,t) and F₂(x,y,t) in accordance with a predetermined format as required) (ST29ab), thereby terminating the encryption processing.

(Decryption Processing: FIGS. 15 and 16)

The decryption apparatus 30 acquires the two encrypted texts F₁(x,y,t) and F₂(x,y,t) from the encrypted text input unit 33 (ST31″), obtains the public key X(x,y,t) and a private key from a key input unit 34 (ST32″), and acquires p and L from a parameter storage unit 31 to start the decryption processing. Here, the private key is one section D. The acquired encrypted texts, key information and others are transmitted to the decrypting unit 35.

Subsequently, the decrypting unit 35 transmits the encrypted text F₁(x,y,t) and the section D to the section assignment unit 42. The section assignment unit 42 assigns D to F₁(x,y,t) and utilizes a one-variable polynomial arithmetic unit 43 as required, thereby obtaining h₁(t) (ST33″). Here, the one-variable polynomial arithmetic unit 43 executes addition/subtraction/multiplication/division of a one-variable polynomial. The obtained h₁(t) is supplied from the section assignment unit 42 to the decrypting unit 35.

Moreover, likewise, the decrypting unit 35 transmits the encrypted text F₂(x,y,t) and the section D to the section assignment unit 42. The section assignment unit 42 assigns the section D to F₂(x,y,t) to obtain h₂(t) (ST34). The obtained h₂(t) is supplied from the section assignment unit 42 to the decrypting unit 35.

Thereafter, the decryption apparatus 30 executes steps ST35 to ST48 as explained above to output the decrypted plaintext m.

As described above, according to this embodiment, even if one section D and two encrypted texts F₁(x,y,t) and F₂(x,y,t) are used, the respective encrypted texts F₁(x,y,t) and F₂(x,y,t) are constituted like the first embodiment. Therefore, even if the encrypted texts F₁ and F₂ are analyzed, a part of f(t) or r₁(x,y,t) and r₂(x,y,t) does not leak. Accordingly, it is possible to avoid leakage of a randomized polynomial in the public key cryptography using an algebraic surface.

<Variation of Second Embodiment>

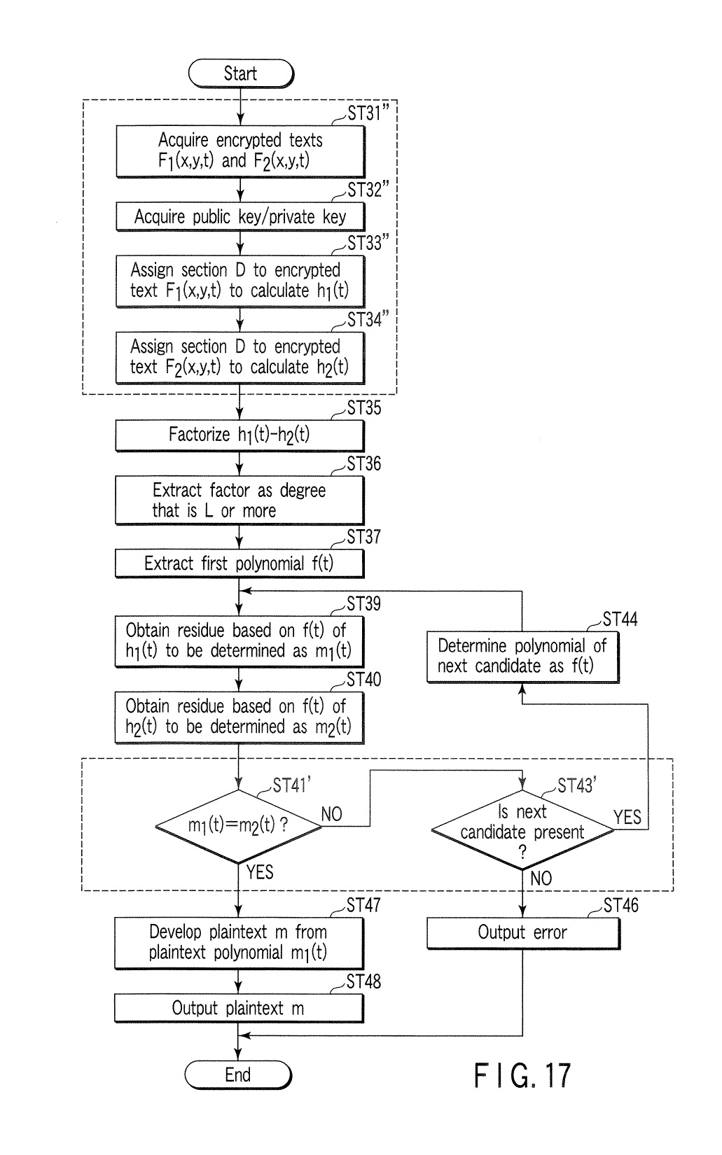

The first variation and the second variation explained in conjunction with the first embodiment can be likewise executed in this embodiment. Moreover, the third variation can be likewise carried out by slightly modifying the third variation of the first embodiment as indicated at the steps ST33″ and ST34″ in FIG. 17.

The invention in its broader aspects is not limited to the specific details and representative embodiments shown and described herein, and can be embodied in their implementation phases by modifying constituent components without departing from the spirit or scope of the general inventive concept of the invention. A variety of modifications of the invention may be made by appropriate combinations of a plurality of constituent components shown in each foregoing embodiment. For example, some constituent components may be omitted from the whole of the constituent components shown in each embodiment. Furthermore, the constituent components over different embodiments can be appropriately combined.

What is claimed is:

1. An encryption apparatus comprising:
an embedding device configured to embed a message m as a coefficient of a plaintext polynomial m(t) having one variable t and a degree that is L−1 or less when encrypting the message m if a fibration X(x,y,t) of an algebraic surface X is a public key and two or more sections corresponding to the fibration X(x,y,t) are private keys;
an irreducible polynomial generation device configured to generate a random one-variable irreducible polynomial f(t) having a degree that is L or more;
a polynomial generation device configured to random three-variable polynomials r(x,y,t) and s(x,y,t) to be constituted of like terms of a variable xⁱy^{j} (where i and j are degrees that are zero or more) when “a multiplication result X(x,y,t)r(x,y,t) of the fibration X(x,y,t) and a three-variable polynomial r(x,y,t)” and “a multiplication result f(t)s(x,y,t) of the random one-variable polynomial f(t) having a degree that is L or more and a three-variable polynomial s(x,y,t)” are regarded as polynomials of x and y; and
an encryption device configured to generate an encrypted text F=Eₚₖ(m,s,r,f,X) from the plaintext polynomial m(t) by processing of executing addition or subtraction using the multiplication result X(x,y,t)r(x,y,t) and the multiplication result f(t)s(x,y,t) with respect to the plaintext polynomial m(t).

2. The apparatus according to claim 1,
wherein the polynomial generation device comprises:
a degree acquisition device configured to acquire a degree L₀ of the one-variable irreducible polynomial f(t);
a selection device configured to select a minimum value dₜ of a degree of the coefficient cᵢⱼ(t) when the fibration X(x,y,t) is determined as a two-variable polynomial Σcᵢⱼ(t)xⁱy^{j};
a first calculation device configured to randomly calculate a constant term r₀₀(t) of the polynomial r(x,y,t) in such a manner that a degree of t becomes L₀−dₜor more when the three-variable polynomial r(x,y,t) is determined as a polynomial of x and y;
a second calculation device configured to randomly calculate a variable term rᵢⱼ(t)xⁱy^{j} other than the constant term r₀₀(t) of the polynomial r(x,y,t) in such a manner that a degree of t becomes L₀−dₜor more;
a third calculation device configured to add the constant term r₀₀(t) to the variable term rᵢⱼ(t)xⁱy^{j} to calculate the three-variable polynomial r(x,y,t);
a multiplication device configured to multiply the fibration X(x,y,t) by the three-variable polynomial r(x,y,t) to obtain a multiplication result X(x,y,t)r(x,y,t);
a fourth calculation device configured to randomly calculate a constant term s₀₀t) of the polynomial s(x,y,t) in such a manner that a degree of t becomes degₜ s′₀₀(t)−L₀ based on a degree degₜ s′₀₀(t) of t in a constant term s′₀₀(t) of the multiplication result X(x,y,t)r(x,y,t) when the three-variable polynomial s(x,y,t) is determined as a polynomial of x and y;
a fifth calculation device configured to randomly calculate a variable term sᵢⱼ(t)xⁱy^{j} of the polynomial s(x,y,t) in such a manner that a degree of t becomes a degₜs′ᵢⱼ(t)−L₀ based on a variable term s′ᵢⱼ(t)xⁱy^{j} other than the constant term s′₀₀(t) of the multiplication result X(x,y,t)r(x,y,t); and
a sixth calculation device configured to add the constant term s₀₀t) to the variable term sᵢⱼ(t)xⁱy^{j} to calculate the three-variable polynomial s(x,y,t).

3. An encryption apparatus comprising:
an embedding device configured to embed a message m as a coefficient of a plaintext polynomial m(t) having one variable t and a degree that is L−1 or less when encrypting the message m if a fibration X(x,y,t) of an algebraic surface X is a public key and a section corresponding to the fibration X(x,y,t) is a private key;
an irreducible polynomial generation device configured to generate a random one-variable irreducible polynomial f(t) having a degree that is L or more;
a first polynomial generation device configured to generate random three-variable polynomials r₁(x,y,t) and s₁(x,y,t) to be constituted of like terms of a variable xⁱy^{j} (where i and j are degrees that are zero or more) when “a multiplication result X(x,y,t)r₁(x,y,t) of the fibration X(x,y,t) and the three-variable term r₁(x,y,t)” and “a multiplication result f(t)s₁(x,y,t) of the random one-variable irreducible polynomial f(t) having a degree that is L or more and the three-variable polynomial s₁(x,y,t)” are regarded as polynomials of x and y;
a first encryption device configured to generate a first encrypted text F₁=Eₚₖ(m,s₁,r₁,f,X) from the plaintext polynomial m(t) by processing of executing addition or subtraction using the multiplication result X(x,y,t)r₁(x,y,t) and the multiplication result f(t)s₁(x,y,t) with respect to the plaintext polynomial m(t);
a second polynomial generation device configured to generate random three-variable polynomials r₂(x,y,t) and s₂(x,y,t) to be constituted of like terms of a variable xⁱy^{j} (where i and j are degrees that are zero or more) when “a multiplication result X(x,y,t)r₂(x,y,t) of the fibration X(x,y,t) and the three-variable term r₂(x,y,t)” and “a multiplication result f(t)s₂(x,y,t) of the random one-variable irreducible polynomial f(t) having a degree that is L or more and the three-variable polynomial s₂(x,y,t)” are regarded as polynomials of x and y; and
a second encryption device configured to generate a second encrypted text F₂=Eₚₖ(m,s₂,r₂,f,X) from the plaintext polynomial m(t) by processing of executing addition or subtraction using the multiplication result X(x,y,t)r₂(x,y,t) and the multiplication result f(t)s₂(x,y,t) with respect to the plaintext polynomial m(t).

4. The apparatus according to claim 3,
wherein the first polynomial generation device comprises:
a degree acquisition device configured to acquire a degree L₀ of the one-variable irreducible polynomial f(t);
a selection device configured to select a minimum value dₜ of a degree of the coefficient cᵢⱼ(t) when the fibration X(x,y,t) is determined as a two-variable polynomial Σcᵢⱼ(t)xⁱy^{j} of x and y;
a first calculation device configured to randomly calculate a constant term r₁_{_{—}}₀₀(t) of the polynomial r₁(x,y,t) in such a manner that a degree of t becomes L₀−dₜor more when the three-variable polynomial r₁(x,y,t) is determined as a polynomial of x and y;
a second calculation device configured to randomly calculate a variable term r₁_{_{—}}ᵢⱼ(t)xⁱy^{j} other than the constant term r₁_{_{—}}₀₀(t) of the polynomial r(x,y,t) in such a manner that a degree of t becomes L₀−dₜor more;
a third calculation device configured to add the constant term r₁_{_{—}}₀₀(t) to the variable term r₁_{_{—}}ᵢⱼ₍ₜ₎ₓⁱy^{j} to calculate the three-variable polynomial r₁(x,y,t);
a first multiplication device configured to multiply the fibration X(x,y,t) by the three-variable polynomial r₁(x,y,t) to obtain a multiplication result X(x,y,t)r₁(x,y,t);
a fourth calculation device configured to randomly calculate a constant term s₁_{_{—}}₀₀(t) of the polynomial s₁(x,y,t) in such a manner that a degree of t becomes degₜ s_{1′00}(t)−L₀ based on a degree degₜ s_{1′00}(t) of t in a constant term s_{1′00}(t) of the multiplication result X(x,y,t)r₁(x,y,t) when the three-variable polynomial s₁(x,y,t) is determined as a polynomial of x and y;
a fifth calculation device configured to randomly calculate a variable term s₁_{_{—}}ᵢⱼ(t)xⁱy^{j} of the polynomial s₁(x,y,t) in such a manner that a degree of t becomes degₜ s_{1′ij}(t)−L₀ based on a variable term s_{1′ij}(t)xⁱy^{j} other than the constant term s₁_{_{—}}₀₀(t) of the polynomial s(x,y,t); and
a sixth calculation device configured to add the constant term s₁_{_{—}}₀₀(t) to the variable term s₁_{_{—}}ᵢⱼ(t)xⁱy^{j} to calculate the three-variable polynomial s₁(x,y,t), and
the second polynomial generation device comprises:
a seventh calculation device configured to randomly calculate a constant term r₂_{_{—}}₀₀(t) of the polynomial r₂(x,y,t) in such a manner that a degree of t becomes L₀−dₜor more when a three-variable polynomial r₂(x,y,t) different from the three-variable polynomial r₁(x,y,t) is determined as a polynomial of x and y;
an eighth calculation device configured to randomly calculate a variable term r₂_{_{—}}ᵢⱼ(t)xⁱy^{j} other than the constant term r₂_{_{—}}₀₀(t) of the polynomial r₂(x,y,t) in such a manner that a degree of t becomes L₀−dₜor more;
a ninth calculation device configured to add the constant term r₂_{_{—}}₀₀(t) to the variable term r₂_{_{—}}ᵢⱼ(t)xⁱy^{j} to calculate the three-variable polynomial r₂(x,y,t);
a second multiplication device configured to multiply the fibration X(x,y,t) by the three-variable polynomial r₂(x,y,t) to obtain a multiplication result X(x,y,t)r₂(x,y,t);
a 10th calculation device configured to randomly calculate a constant term s₂_{_{—}}₀₀(t) of the polynomial s₂(x,y,t) in such a manner that a degree of t becomes degₜ s_{2′00}(t)−L₀ based on a degree degₜ s_{2′00}(t) of t in a constant term s_{2′00}(t) of the multiplication result X(x,y,t)r₂(x,y,t) when the three-variable polynomial s₂(x,y,t) is determined as a polynomial of x and y;
an 11th calculation device configured to randomly calculate a variable term s₂_{_{—}}ᵢⱼ(t)xⁱy^{j} of the polynomial s₂(x,y,t) in such a manner that a degree of t becomes degₜ s_{2′ij}(t)−L₀ based on a variable term s_{2′ij}(t)xⁱy^{j} other than a constant term s_{2′00}(t) of the multiplication result X(x,y,t)r₂(x,y,t); and
a 12th calculation device configured to add the constant term s₂_{_{—}}₀₀(t) to the variable term s₂_{_{—}}ᵢⱼ(t)xⁱy^{j} to calculate the three-variable polynomial s₂(x,y,t).

5. A decryption apparatus comprising:
an input device configured to input an encrypted text F=Eₚₖ(m,s,r,f,X) generated by processing of executing addition or subtraction using “a multiplication result X(x,y,t)r(x,y,t) of a fibration X(x,y,t) and a three-variable polynomial r(x,y,t)” and “a multiplication result f(t)s(x,y,t) of a random one-variable irreducible polynomial f(t) having a degree that is L or more and a three-variable polynomial s(x,y,t)” constituted of like terms of a variable xⁱy^{j} (where i and j are degrees that are 0 or more) when a plaintext polynomial m(t) having one variable t and a degree that is (L−1) or less in which a message m is embedded as a coefficient of the plaintext polynomial m(t) is regarded as a polynomial of x and y in case of decrypting the message m from the encrypted text F generated by using a public key as the fibration X(x,y,t) based on a private key as two or more sections D₁ and D₂ corresponding to the fibration X(x,y,t) of an algebraic surface X;
an assignment device configured to assign the respective sections D₁ and D₂ to the input encrypted text F to generate two one-variable polynomials h₁(t) and h₂(t);
a subtraction device configured to subtract the respective one-variable polynomials h₁(t) and h₂(t) to obtain a subtraction result {h₁(t)−h₂(t)};
a factorization device configured to factorize the subtraction result {h₁(t)−h₂(t)};
an extraction device configured to extract all irreducible polynomials f(t) having degrees that are L or more from a factorization result;
a dividing device configured to divide the one-variable polynomial h₁(t) by the extracted irreducible polynomial f(t) to obtain a polynomial candidate m₁(t) as a residue, and divide the one-variable polynomial h₂(t) by the irreducible polynomial f(t) to obtain a polynomial candidate m₂(t) as a residue;
an inspection device configured to inspect whether the polynomial candidates m₁(t) and m₂(t) match with each other;
a development device configured to develop the message m from the polynomial candidate m₁(t) or m₂(t) when both the candidates match with each other as a result of the inspection;
a control device configured to control the residue arithmetic device to execute the division based on the other extracted irreducible polynomials when both the candidates do not match with each other as a result of the inspection; and
an output device configured to output an error when both the candidates do not match with each other as a result of the inspection and the other irreducible polynomials f(t) are not present.

6. A decryption apparatus comprising:
an input device configured to input an encrypted text F=Eₚₖ(m,s,r,f,X) generated by processing of executing addition or subtraction using “a multiplication result X(x,y,t)r(x,y,t) of a fibration X(x,y,t) and a three-variable polynomial r(x,y,t)” and “a multiplication result f(t)s(x,y,t) of a random one-variable irreducible polynomial f(t) having a degree that is L or more and a three-variable polynomial s(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the plaintext polynomial m(t) is regarded as a polynomial of x and y in case of decrypting the message m from the encrypted text F generated by using a public key as the fibration X(x,y,t) based on a private key as two or more sections D₁ and D₂ corresponding to the fibration X(x,y,t) of an algebraic surface X;
an assignment device configured to assign the respective sections D₁ and D₂ to the input encrypted text F to generate two one-variable polynomials h₁(t) and h₂(t);
a subtraction device configured to subtract the respective one-variable polynomials h₁(t) and h₂(t) to obtain a subtraction result {h₁(t)−h₂(t)};
a factorization device configured to factorize the subtraction result {h₁(t)−h₂(t)};
an extraction device configured to extract all irreducible polynomials f(t) having degrees that are L or more from a factorization result;
a dividing device configured to divide the one-variable polynomial h₁(t) by the extracted irreducible polynomial f(t) to obtain a polynomial candidate m₁(t) as a residue, and divide the one-variable polynomial h₂(t) by the irreducible polynomial f(t) to obtain a polynomial candidate m₂(t) as a residue;
an inspection device configured to inspect whether the polynomial candidates m₁(t) and m₂(t) match with each other;
a development device configured to develop the message m from the polynomial candidate m₁(t) or m₂(t) when both the candidates match with each other as a result of the inspection and one irrespective polynomial f(t) alone is present; and
an output device configured to output an error when both the candidates match with each other as a result of the inspection and no irreducible polynomial f(t) is present or two or more irreducible polynomials f(t) are present.

7. A decryption apparatus comprising:
a first input device configured to input an encrypted text F₁=Eₚₖ(m,s₁, r₁, f, X) generated by processing of executing addition or subtraction using “a multiplication result X(x,y,t)r₁(x,y,t) of a fibration X(x,y,t) and a three-variable polynomial r₁(x,y,t)” and “a multiplication result f(t)s₁(x,y,t) of a random one-variable irreducible polynomial f(t) having a degree that is L or more and a three-variable polynomial s₁(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the plaintext polynomial m(t) is regarded as a polynomial of x and y in case of decrypting the message m from a plurality of encrypted texts F₁ and F₂ generated by using a public key as the fibration X(x,y,t) based on a private key as a section D corresponding to the fibration X(x,y,t) of an algebraic surface X;
a second input device configured to input the encrypted text F₂=Eₚₖ(m,s₂,r₂,f,X) generated by processing of executing addition or subtraction using “a multiplication result X(x,y,t)r₂(x,y,t) of the fibration X(x,y,t) and a three-variable polynomial r₂(x,y,t) (≠r₁(x,y,t))” and “a multiplication result f(t)s₂(x,y,t) of the random one-variable irreducible polynomial f(t) having a degree that is L or more and a three-variable polynomial s₂(x,y,t)” constituted of like terms of a variable xⁱy^{j} (where i and j are degrees that are zero or more) when the plaintext polynomial m(t) is regarded as a polynomial of x and y;
an assignment device configured to assign the section D to the plurality of input encrypted texts F₁ and F₂ to generate two one-variable polynomials h₁(t) and h₂(t);
a subtraction device configured to subtract the respective one-variable polynomials h₁(t) and h₂(t) to obtain a subtraction result {h₁(t)−h₂(t)};
a factorization device configured to factorize the subtraction result {h₁(t)−h₂(t)};
an extraction device configured to extract all irreducible polynomials f(t) having degrees that are L or more from a factorization result;
a dividing device configured to divide the one-variable polynomial h₁(t) by the extracted irreducible polynomial f(t) to obtain a polynomial candidate m₁(t) as a residue, and divide the one-variable polynomial h₂(t) by the irreducible polynomial f(t) to obtain a polynomial candidate m₂(t) as a residue;
an inspection device configured to inspect whether the polynomial candidates m₁(t) and m₂(t) match with each other;
a development device configured to develop the message m from the polynomial candidate m₁(t) or m₂(t) when both the candidates match with each other as a result of the inspection;
a control device configured to control the residue arithmetic device to execute the division by using the other extracted irreducible polynomials f(t) when both the candidates do not match with each other as a result of the inspection; and
an output device configured to output an error when both the candidates do not match with each other as a result of the inspection and the other extracted irreducible polynomials are not present.

8. A decryption apparatus comprising:
a first input device configured to input an encrypted text F₁=Eₚₖ(m,s₁,r₁,f,X) generated by processing of executing addition or subtraction using “a multiplication result X(x,y,t)r₁(x,y,t) of a fibration X(x,y,t) and a three-variable polynomial r₁(x,y,t)” and “a multiplication result f(t)s₁(x,y,t) of a random one-variable irreducible polynomial f(t) having a degree that is L or more and a three-variable polynomial s₁(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the plaintext polynomial m(t) is regarded as a polynomial of x and y in case of decrypting the message m from a plurality of encrypted texts F₁ and F₂ generated by using a public key as the fibration X(x,y,t) based on a private key as a section D corresponding to the fibration X(x,y,t) of an algebraic surface X;
a second input device configured to input the encrypted text F₂=Eₚₖ(m,s₂,r₂,f,X) generated by processing of executing addition or subtraction using “a multiplication result X(x,y,t)r₂(x,y,t) of the fibration X(x,y,t) and a three-variable polynomial r₂(x,y,t) (≠r₁(x,y,t))” and “a multiplication result f(t)s₂(x,y,t) of the random one-variable irreducible polynomial f(t) having a degree that is L or more and a three-variable polynomial s₂(x,y,t)” constituted of like terms of a variable xⁱy^{j} (where i and j are degrees that are zero or more) when the plaintext polynomial m(t) is regarded as a polynomial of x and y;
an assignment device configured to assign the section D to the plurality of input encrypted texts F₁ and F₂ to generate two one-variable polynomials h₁(t) and h₂(t);
a subtraction device configured to subtract the respective one-variable polynomials h₁(t) and h₂(t) to obtain a subtraction result {h₁(t)−h₂(t)};
a factorization device configured to factorize the subtraction result {h₁(t)−h₂(t)};
an extraction device configured to extract all irreducible polynomials f(t) having degrees that are L or more from a factorization result;
a dividing device configured to divide the one-variable polynomial h₁(t) by the extracted irreducible polynomial f(t) to obtain a polynomial candidate m₁(t) as a residue, and divide the one-variable polynomial h₂(t) by the irreducible polynomial f(t) to obtain a polynomial candidate m₂(t) as a residue;
an inspection device configured to inspect whether the polynomial candidates m₁(t) and m₂(t) match with each other;
a development device configured to develop the message m from the polynomial candidate m₁(t) or m₂(t) when both the candidates match with each other as a result of the inspection and one irreducible polynomial f(t) alone is present; and
an output device configured to output an error when both the candidates match with each other as a result of the inspection and no irreducible polynomial f(t) is present or two or more irreducible polynomials f(t) are present.

9. A program stored in a computer-readable storage medium, comprising:
a first program code that allows the computer to execute processing of obtaining a plaintext polynomial m(t) having one variable and a degree that is not L−1 or less by embedding a message m as a coefficient of the plaintext polynomial m(t) when encrypting the message m if a fibration X(x,y,t) of an algebraic surface X is a public key and two or more sections corresponding to the fibration X(x,y,t) are private keys;
a second program code that allows the computer to execute processing of writing the plaintext polynomial m(t) in the memory;
a third program code that allows the computer to execute processing of generating a random one-variable irreducible polynomial f(t) having a degree that is not L or more;
a fourth program code that allows the computer to execute processing of generating random three-variable polynomials r(x,y,t) and s(x,y,t) to be constituted of like terms of a variable xⁱy^{j} (where i and j are degrees that are zero or more) when “a multiplication result X(x,y,t)r(x,y,t) of the fibration X(x,y,t) and the three-variable polynomial r(x,y,t)” and “a multiplication result f(t)s(x,y,t) of the random one-variable irreducible polynomial f(t) having a degree that is L or more and the three-variable polynomial s(x,y,t)” are regarded as polynomials of x and y; and
a fifth program code that allows the computer to execute processing of generating an encrypted text F=Eₚₖ(m,s,r,f,X) from the plaintext polynomial m(t) by processing of executing addition or subtraction using the multiplication result X(x,y,t)r(x,y,t) and the multiplication result f(t)s(x,y,t) with respect to the plaintext polynomial m(t) in the memory.

10. The program according to claim 9, wherein the fourth program code comprises:
a sixth program code that allows the computer to execute processing of acquiring a degree L₀ of the one-variable irreducible polynomial f(t);
a seventh program code that allows the computer to execute processing of selecting a minimum value dₜ of a degree of the coefficient cᵢⱼ(t) when the fibration X(x,y,t) is determined as a two-variable polynomial Σcᵢⱼ(t)xⁱy^{j} of x and y;
an eighth program code that allows the computer to execute processing of randomly calculating a constant term r₀₀(t) of the polynomial r(x,y,t) in such a manner that a degree of t becomes L₀−dₜor more when the three-variable polynomial r(x,y,t) is determined as a polynomial of x and y;
a ninth program code that allows the computer to execute processing of randomly calculating a variable term rᵢⱼ(t)xⁱy^{j} other than the constant term r₀₀(t) of the polynomial r(x,y,t) in such a manner that a degree of t becomes L₀−dₜor more;
a 10th program code that allows the computer to execute processing of adding the constant term r₀₀(t) to the variable term rᵢⱼ(t)xⁱy^{j} to calculate the three-variable polynomial r(x,y,t);
an 11th program code that allows the computer to execute processing of multiplying the fibration X(x,y,t) by the three variable polynomial r(x,y,t) to obtain a multiplication result X(x,y,t)r(x,y,t);
a 12th program code that allows the computer to execute processing of randomly calculating a constant term s₀₀t) of the polynomial s(x,y,t) in such a manner that a degree of t becomes degₜ s′₀₀(t)−L₀ based on a degree degₜ s′₀₀(t) of t of a constant term s′₀₀(t) of the multiplication result X(x,y,t)r(x,y,t) when the three-variable polynomial s(x,y,t) is determined as a polynomial of x and y;
a 13th program code that allows the computer to execute processing of randomly calculating a variable term sᵢⱼ(t)xⁱy^{j} of the polynomial s(x,y,t) in such a manner that a degree of t becomes degₜ s′ᵢⱼ(t)−L₀ based on a variable term s′ᵢⱼ(t)xⁱy^{j} other than the constant term s′₀₀(t) of the multiplication result X(x,y,t)r(x,y,t); and
a 14th program code that allows the computer to execute processing of adding the constant term s₀₀t) to the variable term sᵢⱼ(t)xⁱy^{j} to calculate the three-variable polynomial s(x,y,t).

11. A program stored in a computer-readable storage medium, comprising:
a first program code that allows the computer to execute processing of obtaining a plaintext polynomial m(t) having one variable t and a degree that is L−1 or less by embedding a message m as a coefficient of the plaintext polynomial m(t) when encrypting the message m if a fibration X(x,y,t) of an algebraic surface X is a public key and a section corresponding to the fibration X(x,y,t) is a private key;
a second program code that allows the computer to execute processing of wiring the plaintext polynomial m(t) in the memory;
a third program code that allows the computer to execute processing of generating a random one-variable irreducible polynomial f(t) having a degree that is L or more;
a fourth program code that allows the computer to execute processing of generating random three-variable polynomials r₁(x,y,t) and s₁(x,y,t) to be constituted of like terms of a variable xⁱy^{j} (where i and j are degrees that are zero or more) when “a multiplication result X(x,y,t)r₁(x,y,t) of the fibration X(x,y,t) and the three-variable polynomial r₁(x,y,t)” and “a multiplication result f(t)s₁(x,y,t) of a random one-variable irreducible polynomial f(t) having a degree that is L or more and the three-variable polynomial s₁(x,y,t)” are regarded as polynomials of x and y;
a fifth program code that allows the computer to execute processing of generating a first encrypted text F₁=Eₚₖ(m,s₁,r₁,f,X) from the plaintext polynomial m(t) by processing of executing addition or subtraction using the multiplication result X(x,y,t)r₁(x,y,t) and the multiplication result f(t)s₁(x,y,t) with respect to the plaintext polynomial m(t) in the memory;
a sixth program code that allows the computer to execute processing of generating random three-variable polynomials r₂(x,y,t) and s₂(x,y,t) to be constituted of like terms of a variable xⁱy^{j} (where i and j are degrees that are zero or more) when “a multiplication result X(x,y,t)r₂(x,y,t) of the fibration X(x,y,t) and the three-variable polynomial r₂(x,y,t)” and “a multiplication result f(t)s₂(x,y,t) of a random one-variable irreducible polynomial f(t) having a degree that is L or more and the three-variable polynomial s₂(x,y,t)” are regarded as polynomials x and y; and
a seventh program code that allows the computer to execute processing of generating a second encrypted text F₂=Eₚₖ(m,s₂,r₂,f,X) from the plaintext polynomial m(t) by processing of executing addition or subtraction using the multiplication result X(x,y,t)r₂(x,y,t) and the multiplication result f(t)s₂(x,y,t) with respect to the plaintext m(t) in the memory.

12. The program according to claim 11,
wherein the fourth program code comprises:
an eighth program code that allows the computer to execute processing of acquiring a degree L₀ of the one-variable irreducible polynomial f(t);
a ninth program code that allows the computer to execute processing of selecting a minimum value dₜ of a degree of the coefficient cᵢⱼ(t) when the fibration X(x,y,t) is determined as a two-variable polynomial Σcᵢⱼ(t)xⁱy^{j};
a 10th program code that allows the computer to execute processing of randomly calculating a constant term r₁_{_{—}}₀₀(t) of the polynomial r₁(x,y,t) in such a manner that a degree of t becomes L₀−dₜor more when the three-variable polynomial r₁(x,y,t) is determined as a polynomial of x and y;
an 11th program code that allows the computer to execute processing of randomly calculating a variable term r₁_{_{—}}ᵢⱼ(t)xⁱy^{j} other than the constant term r₁_{_{—}}₀₀(t) of the polynomial r₁(x,y,t) in such a manner that a degree of t becomes L₀−dₜor more;
a 12th program code that allows the computer to execute processing of adding the constant term r₁_{_{—}}₀₀(t) to the variable term r₁ ij(t)xⁱy^{j} to calculate the three-variable polynomial r₁(x,y,t);
a 13th program code that allows the computer to execute processing of multiplying the fibration X(x,y,t) by the three-variable polynomial r₁(x,y,t) to obtain a multiplication result X(x,y,t)r₁(x,y,t);
a 14th program code that allows the computer to execute processing of randomly calculating a constant term s₁_{_{—}}₀₀(t) of the polynomial s₁(x,y,t) in such a manner that a degree of t becomes degₜ s_{1′00}(t)−L₀ based on a degree degₜ s_{1′00}(t) of t of a constant term s_{1′00}(t) of the multiplication result X(x,y,t)r₁(x,y,t) when the three-variable polynomial s₁(x,y,t) is determined as a polynomial of x and y;
a 15th program code that allows the computer to execute processing of randomly calculating a variable term s₁_{_{—}}ᵢⱼ(t)xⁱy^{j} of the polynomial s₁(x,y,t) in such a manner that a degree of t becomes degₜ s_{1′ij}(t)−L₀ based on a variable term s_{1′ij}(t)xⁱy^{j} other than the constant term s_{1′}_{_{—}}₀₀(t) of the multiplication result X(x,y,t) r₁(x,y,t); and
a 16th program code that allows the computer to execute processing of adding the constant term s₁_{_{—}}₀₀(t) to the variable term s₁_{_{—}}ᵢⱼ(t)xⁱy^{j} to calculate the three-variable polynomial s₁(x,y,t), and
the sixth program code comprises:
a 17th program code that allows the computer to execute processing of randomly calculating a constant term r₂_{_{—}}₀₀(t) of the polynomial r₂(x,y,t) in such a manner that a degree of t becomes L₀−dₜor more when a three-variable polynomial r₂(x,y,t) different from the three-variable polynomial r₁(x,y,t) is determined as a polynomial of x and y;
a 18th program code that allows the computer to execute processing of randomly calculating a variable term r₂_{_{—}}ᵢⱼ(t)xⁱy^{j} other than the constant term r₂_{_{—}}₀₀(t) of the polynomial r₂(x,y,t) in such a manner that a degree of t becomes L₀−t_{d} or more;
an 19th program code that allows the computer to execute processing of adding the constant term r₂_{_{—}}₀₀(t) to the variable term r₂_{_{—}}ᵢⱼ(t)xⁱy^{j} to calculate the three-variable polynomial r₂(x,y,t);
a 20th program code that allows the computer to execute processing of multiplying the fibration X(x,y,t) by the three-variable polynomial r₂(x,y,t) to obtain a multiplication result X(x,y,t)r₂(x,y,t);
a 21st program code that allows the computer to execute processing of randomly calculating a constant term s₂_{_{—}}₀₀(t) of the polynomial s₂(x,y,t) in such a manner that a degree of t becomes degₜ s_{2′00}(t)−L₀ based on a degree degₜ s_{2′00}(t) of t of a constant term s_{2′00}(t) of the multiplication result X(x,y,t)r₂(x,y,t) when the three-variable polynomial s₂(x,y,t) is determined as a polynomial of x and y;
a 22nd program code that allows the computer to execute processing of randomly calculating a variable term s₂_{_{—}}ᵢⱼ(t)xⁱy^{j} of the polynomial s₂(x,y,t) in such a manner that a degree of t becomes degₜ s_{2′ij}(t)−L₀ based on a variable term s_{2′ij}(t)xⁱy^{j} other than the constant term s_{2′}_{_{—}}₀₀(t) of the multiplication result X(x,y,t)r₂(x,y,t) ; and
a 23rd program code that allows the computer to execute processing of adding the constant term s₂_{_{—}}₀₀(t) to the variable term s₂_{_{—}}ᵢⱼ(t)xⁱy^{j} to calculate the three-variable polynomial s₂(x,y,t).

13. A program stored in a computer-readable storage medium, comprising:
a first program code that allows the computer to execute processing of receiving an encrypted text F=Eₚₖ(m,s,r,f,X) generated by processing of executing addition or subtraction using “a multiplication result X(x,y,t)r(x,y,t) of a fibration X(x,y,t) and a three-variable polynomial r(x,y,t)” and “a multiplication result f(t)s(x,y,t) of a random one-variable irreducible polynomial f(t) having a degree that is L or more and a three-variable polynomial s(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the plaintext polynomial m(t) is regarded as a polynomial of x and y in case of decrypting the message m from the encrypted text F generated by using a public key as the fibration X(x,y,t) based on a private key as two or more sections D₁ and D₂ corresponding to the fibration X(x,y,t) of an algebraic surface X;
a second program code that allows the computer to execute processing of writing the input encrypted text F in the memory;
a third program code that allows the computer to execute processing of assigning the respective sections D₁ and D₂ to the encrypted text F in the memory to generate two one-variable polynomials h₁(t) and h₂(t);
a fourth program code that allows the computer to execute processing of subtracting the respective one-variable polynomials h₁(t) and h₂(t) to obtain a subtraction result {h₁(t)−h₂(t)};
a fifth program code that allows the computer to execute processing of factorizing the subtraction result {h₁(t)−h₂(t)};
a sixth program code that allows the computer to execute processing of extracting all irreducible polynomials f(t) having degrees that are L or more from a factorization result;
a seventh program code that allows the computer to execute residue arithmetic processing of dividing the one-variable polynomial h₁(t) by the extracted irreducible polynomial f(t) to obtain a polynomial candidate m₁(t) as a residue and dividing the one-variable polynomial h₂(t) by the irreducible polynomial f(t) to acquire a polynomial candidate m₂(t) as a residue;
an eighth program code that allows the computer to execute processing of inspecting whether the polynomial candidates m₁(t) and m₂(t) match with each other;
a ninth program code that allows the computer to execute processing of developing the message m from the polynomial candidate m₁(t) or m₂(t) when both the candidates match with each other as a result of the inspection;
a 10th program code that allows the computer to execute processing of controlling the residue arithmetic processing to execute the division by using the other extracted irreducible polynomials f(t) when both the candidates do not match with each other as a result of the inspection; and
an 11th program code that allows the computer to execute processing of outputting an error when both the candidates do not match with each other as a result of the inspection and the other irreducible polynomials f(t) are not present.

14. A program stored in a computer-readable storage medium, comprising:
a first program code that allows the computer to execute processing of receiving an encrypted text F=Eₚₖ(m,s,r,f,X) generated by processing of executing addition or subtraction using “a multiplication result X(x,y,t)r(x,y,t) of a fibration X(x,y,t) and a three-variable polynomial r(x,y,t)” and “a multiplication result f(t)s(x,y,t) of a random one-variable irreducible polynomial f(t) having a degree that is L or more and a three-variable polynomial s(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the plaintext polynomial m(t) is regarded as a polynomial of x and y in case of decrypting the message m from the encrypted text F generated by using a public key as the fibration X(x,y,t) based on private keys as two or more sections D₁ and D₂ corresponding to the fibration X(x,y,t) of an algebraic surface X;
a second program code that allows the computer to execute processing of writing the input encrypted text F in the memory;
a third program code that allows the computer to execute processing of assigning the respective sections D₁ and D₂ to the encrypted text F in the memory to generate two one-variable polynomials h₁(t) and h₂(t);
a fourth program code that allows the computer to execute processing of subtracting the respective one-variable polynomials h₁(t) and h₂(t) to obtain a subtraction result {h₁(t)−h₂(t)};
a fifth program code that allows the computer to execute processing of factorizing the subtraction result {h₁(t)−h₂(t)};
a sixth program code that allows the computer to execute processing of extracting all irreducible polynomials f(t) having degrees that are L or more from a factorization result;
a seventh program code that allows the computer to execute processing of dividing the one-variable polynomial h₁(t) by the extracted irreducible polynomial f(t) to obtain a polynomial candidate m₁(t) as a residue, and dividing the one-variable polynomial h₂(t) by the irreducible polynomial f(t) to obtain a polynomial candidate m₂(t) as a residue;
an eighth program code that allows the computer to execute processing of inspecting whether the polynomial candidates m₁(t) and m₂(t) match with each other;
a ninth program code that allows the computer to execute processing of developing the message m from the polynomial candidate m₁(t) or m₂(t) when both the candidates match with each other as a result of the inspection and one irreducible polynomial f(t) alone is present; and
a 10th program code that allows the computer to execute processing of outputting an error when both the candidates match with each other as a result of the inspection and no irreducible polynomial f(t) is present or two or more irreducible polynomials f(t) are present.

15. A program stored in a computer-readable storage medium, comprising:
a first program code that allows the computer to execute processing of receiving an encrypted text F₁=Eₚₖ(m,s₁,r₁,f,X) generated by processing of executing addition or subtraction using “a multiplication result X(x,y,t)r₁(x,y,t) of a fibration X(x,y,t) and a three-variable polynomial r₁(x,y,t)” and “a multiplication result f(t)s₁(x,y,t) of a random one-variable irreducible polynomial f(t) having a degree that is L or more and a three-variable polynomial s₁(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the plaintext polynomial m(t) is regarded as a polynomial of x and y in case of decrypting the message m from a plurality of encrypted texts F₁ and F₂ generated by using a public key as the fibration X(x,y,t) based on a private key as a section D corresponding to the fibration X(x,y,t) of an algebraic surface X;
a second program code that allows the computer to execute processing of receiving the encrypted text F₂=Eₚₖ(m,s₂,r₂,f,X) generated by processing of executing addition or subtraction using “a multiplication result X(x,y,t)r₂(x,y,t) of the fibration X(x,y,t) and a three-variable polynomial r₂(x,y,t) (≠r₁(x,y,t))” and “a multiplication result f(t)s₂(x,y,t) of the random one-variable irreducible polynomial f(t) having a degree that is L or more and a three-variable polynomial s₂(x,y,t)” constituted of like terms of a variable xⁱy^{j} (where i and j are degrees that are zero or more) when the plaintext polynomial m(t) is regarded as a polynomial of x and y;
a third program code that allows the computer to execute processing of writing the plurality of input encrypted texts F₁ and F₂ in the memory;
a fourth program code that allows the computer to execute processing of assigning the section D to the respective encrypted texts F₁ and F₂ in the memory to generate two one-variable polynomials h₁(t) and h₂(t);
a fifth program code that allows the computer to execute processing of subtracting the respective one-variable polynomials h₁(t) and h₂(t) to obtain a subtraction result {h₁(t)−h₂(t)};
a sixth program code that allows the computer to execute processing of factorizing the subtraction result {h₁ (t)−h₂ (t)};
a seventh program code that allows the computer to execute processing of extracting all irreducible polynomials f(t) having degrees that are L or more from a factorization result;
an eighth program code that allows the computer to execute residue arithmetic processing of dividing the one-variable polynomial h₁(t) by the extracted irreducible polynomial f(t) to obtain a polynomial candidate m₁(t) as a residue and dividing the one-variable polynomial h₂(t) by the irreducible polynomial f(t) to obtain a polynomial candidate m₂(t) as a residue;
a ninth program code that allows the computer to execute processing of inspecting whether the polynomial candidates m₁(t) and m₂(t) match with each other;
a 10th program code that allows the computer to execute processing of developing the message m from the polynomial candidate m₁(t) or m₂(t) when both the candidates match with each other as a result of the inspection;
an 11th program code that allows the computer to execute processing of controlling the residue arithmetic processing to execute the division by using the other extracted irreducible polynomials f(t) when both the candidates do not match with each other as a result of the inspection; and
a 12th program code that allows the computer to execute processing of outputting an error when both the candidates do not match with each other as a result of the inspection and the other irreducible polynomials f(t) are not present.

16. A program stored in a computer-readable storage medium, comprising:
a first program code that allows the computer to execute processing of receiving an encrypted text F₁=Eₚₖ(m,s₁,r₁,f,X) generated by processing of executing addition or subtraction using “a multiplication result X(x,y,t)r₁(x,y,t) of a fibration X(x,y,t) and a three-variable polynomial r₁(x,y,t)” and “a multiplication result f(t)s₁(x,y,t) of a random one-variable irreducible polynomial f(t) having a degree that is L or more and a three-variable polynomial s₁(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the plaintext polynomial m(t) is regarded as a polynomial x and y in case of decrypting the message m from a plurality of encrypted texts F₁ and F₂ generated by using a public key as the fibration X(x,y,t) based on a private key as a section D corresponding to the fibration X(x,y,t) of an algebraic surface X;
a second program code that allows the computer to execute processing of receiving the encrypted text F₂=Eₚₖ(m,s₂,r₂,f,X) generated by processing of executing addition or subtraction using “a multiplication result X(x,y,t)r₂(x,y,t) of the fibration X(x,y,t) and a three-variable polynomial r₂(x,y,t) (≠r₁(x,y,t)) and “a multiplication result f(t)s₂(x,y,t) of the random one-variable irreducible polynomial f(t) having a degree that is L or more and a three-variable polynomial s₂(x,y,t)” constituted of like terms of a variable xⁱy^{j} (where i and j are degrees that are zero or more) when the plaintext polynomial m(t) is regarded as a polynomial of x and y;
a third program code that allows the computer to execute processing of writing the plurality of input encrypted texts F₁ and F₂ in the memory;
a fourth program code that allows the computer to execute processing of assigning the section D to the respective encrypted texts F₁ and F₂ in the memory to generate two one-variable polynomials h₁(t) and h₂(t);
a fifth program code that allows the computer to execute processing of subtracting the respective one-variable polynomials h₁(t) and h₂(t) to obtain a subtraction result {h₁(t)−h₂(t)};
a sixth program code that allows the computer to execute processing of factorizing the subtraction result {h₁(t)−h₂(t)};
a seventh program code that allows the computer to execute processing of extracting all irreducible polynomials f(t) having degrees that are L or more from a factorization result;
an eighth program code that allows the computer to execute processing of dividing the one-variable polynomial h₁(t) by the extracted irreducible polynomial f(t) to obtain a polynomial candidate m₁(t) as a residue and dividing the one-variable polynomial h₂(t) by the irreducible polynomial f(t) to obtain a polynomial candidate m₂(t) as a residue;
a ninth program code that allows the computer to execute processing of inspecting whether the polynomial candidates m₁(t) and m₂(t) match with each other;
a 10th program code that allows the computer to execute processing of developing the message m from the polynomial candidate m₁(t) or m₂(t) when both the candidates match with each other as a result of the inspection and one irreducible polynomial f(t) alone is present; and
an 11th program code that allows the computer to execute processing of outputting an error when both the candidates match with each other as a result of the inspection and no irreducible polynomial f(t) is present or two or more irreducible polynomials f(t) are present.

17. An encryption method executed by an encryption apparatus, comprising:
obtaining a plaintext polynomial m(t) having one variable t and a degree that is L−1 or less by embedding a message m as a coefficient of the plaintext polynomial m(t) in case of encrypting the message m when a fibration X(x,y,t) of an algebraic surface X is a public key and two or more sections corresponding to the fibration X(x,y,t) are private keys;
writing the plaintext polynomial m(t) in a memory of the encryption apparatus;
generating a random one-variable irreducible polynomial f(t) having a degree that is L or more;
generating random three-variable polynomials r(x,y,t) and s(x,y,t) to be constituted of like terms of a variable xⁱy^{j} (where i and j are degrees that are zero or more) when “a multiplication result X(x,y,t)r(x,y,t) of the fibration X(x,y,t) and a three-variable polynomial r(x,y,t)” and “a multiplication result f(t)s(x,y,t) of the random one-variable irreducible polynomial f(t) having a degree that is L or more and a three-variable polynomial s(x,y,t)” are regarded as polynomials of x and y; and
generating an encrypted text F=Eₚₖ(m,s,r,f,X) from the plaintext polynomial m(t) by processing of executing addition or subtraction using the multiplication result X(x,y,t)r(x,y,t) and the multiplication result f(t)s(x,y,t) with respect to the plaintext polynomial m(t) in the memory.

18. An encryption method executed by an encryption apparatus, comprising:
obtaining a plaintext polynomial m(t) having one variable t and a degree that is L−1 or less by embedding a message m as a coefficient of the plaintext polynomial m(t) in case of encrypting the message m when a fibration X(x,y,t) of an algebraic surface X is a public key and a section corresponding to the fibration X(x,y,t) is a private key;
writing the plaintext polynomial m(t) in a memory of the encryption apparatus;
generating a random one-variable irreducible polynomial f(t) having a degree that is L or more;
generating random three-variable polynomials r₁(x,y,t) and s₁(x,y,t) to be constituted of like terms of a variable xⁱy^{j} (where i and j are degrees that are zero or more) when “a multiplication result X(x,y,t)r₁(x,y,t) of the fibration X(x,y,t) and a three-variable polynomial r₁(x,y,t)” and “a multiplication result f(t)s₁(x,y,t) of the random one-variable irreducible polynomial f(t) having a degree that is L or more and a three-variable polynomial s₁(x,y,t)” are regarded as polynomials of x and y”;
generating a first encrypted text F₁=Eₚₖ(m,s₁,r₁,f,X) from the plaintext polynomial m(t) by processing of executing addition or subtraction using the multiplication result X(x,y,t)r₁(x,y,t) and the multiplication result f(t)s₁(x,y,t) with respect to the plaintext polynomial m(t) in the memory;
generating random three-variable polynomials r₂(x,y,t) and s₂(x,y,t) to be constituted of like terms of a variable xⁱy^{j} (where i and j are degrees that are zero or more) when “a multiplication result X(x,y,t)r₂(x,y,t) of the fibration X(x,y,t) and a three-variable polynomial r₂(x,y,t)” and “a multiplication result f(t)s₂(x,y,t) of the random one-variable irreducible polynomial f(t) having a degree that is L or more and a three-variable polynomial s₂(x,y,t)” are regarded as polynomials of x and y; and
generating a second encrypted text F₂=Eₚₖ(m,s₂,r₂,f,X) from the plaintext polynomial m(t) by processing of executing addition or subtraction using the multiplication result X(x,y,t)r₂(x,y,t) and the multiplication result f(t)s₂(x,y,t) with respect to the plaintext polynomial m(t) in the memory.

19. A decryption method executed by a decryption apparatus, comprising:
receiving an encrypted text F=Eₚₖ(m,s,r,f,X) generated by processing of executing addition or subtraction using “a multiplication result X(x,y,t)r(x,y,t) of a fibration X(x,y,t) and a three-variable polynomial r(x,y,t)” and “a multiplication result f(t)s(x,y,t) of a random one-variable irreducible polynomial f(t) having a degree that is L or more and a three-variable polynomial s(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the plaintext polynomial m(t) is regarded as a polynomial of x and y in case of decrypting the message m from the encrypted text F generated by using a public key as the fibration X(x,y,t) based on private keys as two or more sections D₁ and D₂ corresponding to the fibration X(x,y,t) of an algebraic surface X;
assigning the respective sections D₁ and D₂ to the input encrypted text F to generate two one-variable polynomials h₁(t) and h₂(t);
subtracting the respective one-variable polynomials h₁(t) and h₂(t) to obtain a subtraction result {h₁(t)−h₂(t) };
factorizing the subtraction result {h₁(t)−h₂(t)};
extracting all irreducible polynomials f(t) having degrees that are L or more from a factorization result;
executing residue arithmetic processing of dividing the one-variable polynomial h₁(t) by the extracted irreducible polynomial f(t) to obtain a polynomial candidate m₁(t) as a residue and dividing the one-variable polynomial h₂(t) by the irreducible polynomial f(t) to obtain a polynomial candidate m₂(t) as a residue;
inspecting whether the polynomial candidates m₁(t) and m₂(t) match with each other;
developing the message m from the polynomial candidate m₁(t) or m₂(t) when both the candidates match with each other as a result of the inspection;
controlling the residue arithmetic processing to execute the division by using the other extracted irreducible polynomials f(t) when both the candidates do not match with each other as a result of the inspection; and
outputting an error when both the candidates do not match with each other as a result of the inspection and the other irreducible polynomials f(t) are not present.

20. A decryption method executed by a decryption apparatus, comprising:
receiving an encrypted text F=Eₚₖ(m,s,r,f,X) generated by processing of executing addition of addition and subtraction using “a multiplication result X(x,y,t)r(x,y,t) of a fibration X(x,y,t) and a three-variable polynomial r(x,y,t)” and “a multiplication result f(t)s(x,y,t) of a random one-variable irreducible polynomial f(t) having a degree that is L or more and a three-variable polynomial s(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the polynomial m(t) is regarded as a polynomial of x and y in case of decrypting the message m from the encrypted text F generated by using a public key as the Vibration X(x,y,t) based on private keys as two or more sections D₁ and D₂ corresponding to the fibration X(x,y,t) of an algebraic surface X;
assigning the respective sections D₁ and D₂ to the input encrypted text F to generate two one-variable polynomials h₁(t) and h₂(t);
subtracting the respective one-variable polynomials h₁(t) and h₂(t) to obtain a subtraction result {h₁(t)−h₂(t)};
factorizing the subtraction result {h₁(t)−h₂(t)};
extracting all irreducible polynomials f(t) having degrees that are L or more from a factorization result;
dividing the one-variable polynomial h₁(t) by the extracted irreducible polynomial f(t) to obtain a polynomial candidate m₁(t) as a residue and dividing the one-variable polynomial h₂(t) by the irreducible polynomial f(t) to obtain a polynomial candidate m₂(t) as a residue;
inspecting whether the polynomial candidates m₁(t) and m₂(t) match with each other;
developing the message m from the polynomial candidate m₁(t) or m₂(t) when both the candidates match with each other as a result of the inspection and one irreducible polynomial f(t) alone is present; and
outputting an error when both the candidates match with each other as a result of the inspection and no irreducible polynomial f(t) is present or two or more irreducible polynomials f(t) are present.

21. A decryption method executed by a decryption apparatus, comprising:
receiving an encrypted text F₁=Eₚₖ(m,s₁,r₁,f,X) generated by processing of executing addition or subtraction using “a multiplication result X(x,y,t)r₁(x,y,t) of a fibration X(x,y,t) and a three-variable polynomial r₁(x,y,t)” and “a multiplication result f(t)s₁(x,y,t) of a random one-variable irreducible polynomial f(t) having a degree that is L or more and a three-variable polynomial s₁(x,y,t)” constituted of like terms of a variable xⁱy^{j} (where i and h are degrees that are zero or more) when a plaintext polynomial m(t) having one variable t and a degree that is (L−1) or less in which a message m is embedded as a coefficient of the plaintext polynomial m(t) is regarded as a polynomial of x and y in case of decrypting the message m from a plurality of encrypted texts F₁ and F₂ generated by using a public key as the fibration X(x,y,t) based on a private key as a section D corresponding to the fibration X(x,y,t) of an algebraic surface X;
receiving the encrypted text F₂=Eₚₖ(m,s₂,r₂,f,X) generated by processing of executing addition or subtraction using “a multiplication result X(x,y,t)r₂(x,y,t) of the fibration X(x,y,t) and a three-variable polynomial r₂(x,y,t) (≠r₁(x,y,t))” and “a multiplication result f(t)s₂(x,y,t) of the random one-variable irreducible polynomial f(t) having a degree that is L or more and a three-variable polynomial s₂(x,y,t)” constituted of like terms of a variable xⁱy^{j} (where i and j are degrees that are zero or more) when the plaintext polynomial m(t) is regarded as a polynomial of x and y;
assigning the section D to the plurality of input encrypted texts F₁ and F₂ to generate two one-variable polynomials h₁(t) and h₂(t);
subtracting the respective one-variable polynomials h₁(t) and h₂(t) to obtain a subtraction result {h₁(t)−h₂(t)};
factorizing the subtraction result {h₁(t)−h₂(t)};
extracting all irreducible polynomials f(t) having degrees that are L or more from a factorization result;
executing a residue arithmetic processing of dividing the one-variable polynomial h₁(t) by the extracted irreducible polynomial f(t) to obtain a polynomial candidate m₁(t) as a residue and dividing the one-variable polynomial h₂(t) by the irreducible polynomial f(t) to obtain a polynomial candidate m₂(t) as a residue;
a plaintext polynomial inspection step of inspecting whether the polynomial candidates m₁(t) and m₂(t) match with each other;
developing the message m from the polynomial candidate m₁(t) or m₂(t) when both the candidates match with each other;
controlling the residue arithmetic processing to execute the division by using the other extracted irreducible polynomials f(t) when both the candidates do not match with each other as a result of the inspection; and
outputting an error when both the candidates do not match with each other as a result of the inspection and the other irreducible polynomials f(t) are not present.

22. A decryption method executed by a decryption apparatus, comprising:
receiving an encrypted text F₁=Eₚₖ(m,s₁,r₁,f,X) generated by processing of executing addition or subtraction using “a multiplication result X(x,y,t)r₁(x,y,t) of a fibration X(x,y,t) and a three-variable polynomial r₁(x,y,t)” and “a multiplication result f(t)s₁(x,y,t) of a random one-variable irreducible polynomial f(t) having a degree that is L or more and a three-variable polynomial s₁(x,y,t)” constituted of like terms of a variable xⁱy^{j} (where i and j are degrees that are zero or more) when a plaintext polynomial m(t) having one variable t and a degree that is (L−1) or less in which a message m is embedded as a coefficient of the plaintext polynomial m(t) is regarded as a polynomial of x and y in case of decrypting the message m from a plurality of encrypted texts F₁ and F₂ generated by using a public key as the fibration X(x,y,t) based on a private key as a section D corresponding to the fibration X(x,y,t) of an algebraic surface X;
receiving the encrypted text F₂=Eₚₖ(m,s₂,r₂,f,X) generated by processing of executing addition or subtraction using “a multiplication result X(x,y,t)r₂(x,y,t) of the fibration X(x,y,t) and a three-variable polynomial r₂(x,y,t) (≠r₁(x,y,t)) and “a multiplication result f(t)s₂(x,y,t) of the random one-variable irreducible polynomial f(t) having a degree that is L or more and a three-variable polynomial s₂(x,y,t)” constituted of like terms of a variable xⁱy^{j} (where i and j are degrees that are zero or more) when the plaintext polynomial m(t) is regarded as a polynomial of x and y;
assigning the section D to the plurality of input encrypted texts F₁ and F₂ to generate two one-variable polynomials h₁(t) and h₂(t);
subtracting the respective one-variable polynomials h₁(t) and h₂(t) to obtain a subtraction result {h1(t)−h2(t)};
factorizing the subtraction result {h₁(t)−h₂(t)};
extracting all irreducible polynomials f(t) having degrees that are L or more from a factorization result;
dividing the one-variable polynomial h₁(t) by the extracted irreducible polynomial f(t) to obtain a polynomial candidate m₁(t) as a residue and dividing the one-variable polynomial h₂(t) by the irreducible polynomial f(t) to obtain a polynomial candidate m₂(t) as a residue;
a plaintext polynomial inspection step of inspecting whether the polynomial candidates m₁(t) and m₂(t) match with each other;
developing the message m from the polynomial candidate m₁(t) or m₂(t) when both the candidates match with each other as a result of the inspection and one irreducible polynomial f(t) alone is present; and
outputting an error when both the candidates match with each other as a result of the inspection and no irreducible polynomial f(t) is present or two or more irreducible polynomials f(t) are present.
